(19) United States
(12) Patent Application Publication
(10) Pub. No.: US 2025/0048152 A1
(43) Pub. Date: Feb. 6, 2025

(54) TECHNIQUES FOR EVENT-TRIGGERED BEAM GROUP REPORTING

(71) Applicant: QUALCOMM INCORPORATED, San Diego, CA (US)

(72) Inventors: Fang Yuan, Beijing (CN); Yan Zhou, San Diego, CA (US); Tao Luo, San Diego, CA (US)

(21) Appl. No.: 18/708,990

(22) PCT Filed: Jan. 6, 2022
(86) PCT No.: PCT/CN2022/070465

§ 371 Date: May 9, 2024

(51) Int. Cl. H04W 24/10; H04B 7/06

(52) U.S. Cl. CPC H04W 24/10; H04B 7/0626; H04B 7/0632

(57) ABSTRACT

Methods, systems, and devices for wireless communications are described. A user equipment (UE) may be configured to receive control signaling indicating a beam group reporting configuration including a trigger condition for reporting channel state information (CSI) associated with multiple beam groups each including multiple beams. The UE may transmit a first uplink message including an indication that the trigger condition has been satisfied, and may transmit a second uplink message including a measurement report that includes CSI associated with at least a first beam group of the multiple beam groups, the first beam group being associated with satisfaction of the trigger condition. The UE may then receive, in response to the second uplink message, additional control signaling including beam information for communications between the base station and the UE, and may communicate with the base station in accordance with the beam information.

### CROSS REFERENCE

The present application is a 371 national stage filing of International PCT Application No. PCT/CN2022/070465 by Yuan et al, entitled “TECHNIQUES FOR EVENT-TRIGGERED BEAM GROUP REPORTING,” filed Jan. 6, 2022, which is assigned to the assignee hereof, and which is expressly incorporated by reference in its entirety herein.

### FIELD OF TECHNOLOGY

The following relates to wireless communications, including techniques for event-triggered beam group reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, wireless devices (e.g., UEs) perform measurements on reference signals (e.g., channel state information reference signals (CSI-RSs)) received from the network, and transmit measurement reports (e.g., CSI reports) indicating the measurements, thus enabling the network to determine channel conditions and determine which beams should be used for wireless communications with the UE.

### SUMMARY

The described techniques relate to improved methods, systems, devices, and apparatuses that support techniques for event-triggered beam group reporting. Generally, aspects of the present disclosure support techniques for event-triggered beam group reporting. In particular, aspects of the present disclosure may support signaling and other configurations which enable user equipments (UEs) to perform channel state information (CSI) reporting for beam groups (e.g., groups of multiple beams) upon a satisfaction of some trigger condition (e.g., event-triggered group-based CSI reporting). For example, a UE may receive a CSI reporting configuration for reporting CSI information for beam groups at the UE, where the CSI reporting configuration includes trigger conditions for group-based CSI reporting. Upon identifying a satisfaction of a trigger condition, the may UE transmit an uplink message (e.g., uplink control information (UCI) message, medium access control-control element (MAC-CE)) indicating the satisfaction of the trigger condition, and may subsequently transmit a second uplink message including a measurement report (e.g., CSI report) for at least one beam group that satisfied the trigger condition. The UE may then receive updated beam information from the base station in response to the measurement report, and may communicate in accordance with the updated beam information.

A method for wireless communication at a UE is described. The method may include receiving, from a base station, control signaling indicating a beam group reporting configuration that includes a trigger condition for reporting, by the UE, CSI associated with a set of multiple beam groups that each include multiple beams, transmitting, to the base station in accordance with the beam group reporting configuration, a first uplink message including an indication that the trigger condition has been satisfied, transmitting, to the base station and based on transmission of the first uplink message, a second uplink message including a measurement report that includes CSI associated with at least a first beam group of the set of multiple beam groups, the first beam group associated with satisfaction of the trigger condition, receiving, in response to the second uplink message, additional control signaling including beam information for communications between the base station and the UE, and communicating with the base station in accordance with the beam information.

An apparatus for wireless communication at a UE is described. The apparatus may include a processor, memory coupled with the processor, and instructions stored in the memory. The instructions may be executable by the processor to cause the apparatus to receive, from a base station, control signaling indicating a beam group reporting configuration that includes a trigger condition for reporting, by the UE, CSI associated with a set of multiple beam groups that each include multiple beams, transmit, to the base station in accordance with the beam group reporting configuration, a first uplink message including an indication that the trigger condition has been satisfied, transmit, to the base station and based on transmission of the first uplink message, a second uplink message including a measurement report that includes CSI associated with at least a first beam group of the set of multiple beam groups, the first beam group associated with satisfaction of the trigger condition, receive, in response to the second uplink message, additional control signaling including beam information for communications between the base station and the UE, and communicate with the base station in accordance with the beam information.

Another apparatus for wireless communication at a UE is described. The apparatus may include means for receiving, from a base station, control signaling indicating a beam group reporting configuration that includes a trigger condition for reporting, by the UE, CSI associated with a set of multiple beam groups that each include multiple beams, means for transmitting, to the base station in accordance with the beam group reporting configuration, a first uplink message including an indication that the trigger condition has been satisfied, means for transmitting, to the base station and based on transmission of the first uplink message, a second uplink message including a measurement report that includes CSI associated with at least a first beam group of the set of multiple beam groups, the first beam group associated with satisfaction of the trigger condition, means for receiving, in response to the second uplink message, additional control signaling including beam information for communications between the base station and the UE, and means for communicating with the base station in accordance with the beam information.

A non-transitory computer-readable medium storing code for wireless communication at a UE is described. The code may include instructions executable by a processor to receive, from a base station, control signaling indicating a beam group reporting configuration that includes a trigger condition for reporting, by the UE, CSI associated with a set of multiple beam groups that each include multiple beams, transmit, to the base station in accordance with the beam group reporting configuration, a first uplink message including an indication that the trigger condition has been satisfied, transmit, to the base station and based on transmission of the first uplink message, a second uplink message including a measurement report that includes CSI associated with at least a first beam group of the set of multiple beam groups, the first beam group associated with satisfaction of the trigger condition, receive, in response to the second uplink message, additional control signaling including beam information for communications between the base station and the UE, and communicate with the base station in accordance with the beam information.

Some examples of the method, apparatuses, and non-transitory computer-readable medium described herein may further include operations, features, means, or instructions for transmitting, via the first uplink message and based on satisfaction of the trigger condition, a request for a resource for communicating the second uplink message and receiving, from the base station and in response to the request, an indication of the resource, where the second uplink message may be transmitted within the resource.

Some examples of the method, apparatuses, and non-transitory computer-readable medium described herein may further include operations, features, means, or instructions for transmitting the request via one or more bit fields within the first uplink message that may be associated with reporting CSI associated with the set of multiple beam groups.

In some examples of the method, apparatuses, and non-transitory computer-readable medium described herein, the beam information includes an indication of one or more beams to be used in communications between the UE and the base station and the method, apparatuses, and non-transitory computer-readable medium may include further operations, features, means, or instructions for communicating with the base station using the one or more beams.

Some examples of the method, apparatuses, and non-transitory computer-readable medium described herein may further include operations, features, means, or instructions for receiving, from the base station via the control signaling, second control signaling, or both, an indication of a set of resources for communicating requests associated with reporting CSI by the UE, where the first uplink message may be transmitted within a resource of the set of resources.

Some examples of the method, apparatuses, and non-transitory computer-readable medium described herein may further include operations, features, means, or instructions for transmitting, via the first uplink message, an indication of a CSI report identifier associated with the measurement report, an indication of a first beam group identifier associated with the first beam group, or both, where transmitting the second uplink message, receiving the additional control signaling, or both, may be based on the CSI report identifier, the first beam group identifier, or both.

Some examples of the method, apparatuses, and non-transitory computer-readable medium described herein may further include operations, features, means, or instructions for identifying that the trigger condition may have been satisfied based on a first beam quality metric associated with the first beam group satisfying a reference beam quality metric, where transmitting the first uplink message may be based on identifying that the trigger condition may have been satisfied.

Some examples of the method, apparatuses, and non-transitory computer-readable medium described herein may further include operations, features, means, or instructions for identifying that the trigger condition may have been satisfied based on a set of multiple beam quality metrics associated with the set of multiple beam groups each satisfying a reference beam quality metric, where transmitting the first uplink message may be based on identifying that the trigger condition may have been satisfied.

Some examples of the method, apparatuses, and non-transitory computer-readable medium described herein may further include operations, features, means, or instructions for receiving, from the base station, an activation of a set of multiple transmission configuration indicator (TCI) states, where the reference beam quality metric includes a beam quality metric associated with one or more activated TCI states of the set of multiple TCI states.

Some examples of the method, apparatuses, and non-transitory computer-readable medium described herein may further include operations, features, means, or instructions for receiving, via the control signaling, an indication of the reference beam quality metric, where identifying that the trigger condition may have been satisfied may be based on receiving the indication of the reference beam quality metric.

In some examples of the method, apparatuses, and non-transitory computer-readable medium described herein, the first beam group includes a set of multiple beams and the first beam quality metric includes an average beam quality metric associated with the set of multiple beams, a minimum beam quality metric associated with the set of multiple beams, a maximum beam quality metric associated with the set of multiple beams, or any combination thereof.

Some examples of the method, apparatuses, and non-transitory computer-readable medium described herein may further include operations, features, means, or instructions for receiving, via the control signaling, second control signaling, or both, an indication of a set of multiple reference signal sets, receiving a set of multiple reference signals associated with the set of multiple reference signal sets using at least a subset of beam groups of the set of multiple beam groups, and identifying that the trigger condition may have been satisfied based on receiving the set of multiple reference signals, where transmitting the first uplink message may be based on identifying that the trigger condition may have been satisfied.

In some examples of the method, apparatuses, and non-transitory computer-readable medium described herein, the set of multiple reference signal sets may be associated with one another and each reference signal set of the set of multiple reference signal sets includes periodic measurement resources, semi-persistent measurement resources, or both.

In some examples of the method, apparatuses, and non-transitory computer-readable medium described herein, the first uplink message includes a random access channel (RACH) message, an uplink control message, a MAC-CE message, or any combination thereof.

In some examples of the method, apparatuses, and non-transitory computer-readable medium described herein, the measurement report includes an indication of one or more measurements associated with the first beam group, the one or more measurements including a layer one (L1) reference signal received power (RSRP) measurement, an L1 signal-to-interference-plus-noise ratio (SINR) measurement, a power headroom (PHR) measurement, a maximum permissible exposure (MPE) measurement, a layer three (L3) RSRP measurement, an L3-SINR measurement, or any combination thereof.

A method for wireless communication at a base station is described. The method may include transmitting, to a UE, control signaling indicating a beam group reporting configuration that includes a trigger condition for reporting, by the UE, CSI associated with a set of multiple beam groups that each include multiple beams, receiving, from the UE in accordance with the beam group reporting configuration, a first uplink message including an indication that the trigger condition has been satisfied, receiving, from the UE and based on the first uplink message, a second uplink message including a measurement report that includes CSI associated with at least a first beam group of the set of multiple beam groups, the first beam group being associated with satisfaction of the trigger condition, transmitting, in response to the second uplink message, additional control signaling including beam information for communications between the base station and the UE, and communicating with the UE in accordance with the beam information.

An apparatus for wireless communication at a base station is described. The apparatus may include a processor, memory coupled with the processor, and instructions stored in the memory. The instructions may be executable by the processor to cause the apparatus to transmit, to a UE, control signaling indicating a beam group reporting configuration that includes a trigger condition for reporting, by the UE, CSI associated with a set of multiple beam groups that each include multiple beams, receive, from the UE in accordance with the beam group reporting configuration, a first uplink message including an indication that the trigger condition has been satisfied, receive, from the UE and based on the first uplink message, a second uplink message including a measurement report that includes CSI associated with at least a first beam group of the set of multiple beam groups, the first beam group being associated with satisfaction of the trigger condition, transmit, in response to the second uplink message, additional control signaling including beam information for communications between the base station and the UE, and communicate with the UE in accordance with the beam information.

Another apparatus for wireless communication at a base station is described. The apparatus may include means for transmitting, to a UE, control signaling indicating a beam group reporting configuration that includes a trigger condition for reporting, by the UE, CSI associated with a set of multiple beam groups that each include multiple beams, means for receiving, from the UE in accordance with the beam group reporting configuration, a first uplink message including an indication that the trigger condition has been satisfied, means for receiving, from the UE and based on the first uplink message, a second uplink message including a measurement report that includes CSI associated with at least a first beam group of the set of multiple beam groups, the first beam group being associated with satisfaction of the trigger condition, means for transmitting, in response to the second uplink message, additional control signaling including beam information for communications between the base station and the UE, and means for communicating with the UE in accordance with the beam information.

A non-transitory computer-readable medium storing code for wireless communication at a base station is described. The code may include instructions executable by a processor to transmit, to a UE, control signaling indicating a beam group reporting configuration that includes a trigger condition for reporting, by the UE, CSI associated with a set of multiple beam groups that each include multiple beams, receive, from the UE in accordance with the beam group reporting configuration, a first uplink message including an indication that the trigger condition has been satisfied, receive, from the UE and based on the first uplink message, a second uplink message including a measurement report that includes CSI associated with at least a first beam group of the set of multiple beam groups, the first beam group being associated with satisfaction of the trigger condition, transmit, in response to the second uplink message, additional control signaling including beam information for communications between the base station and the UE, and communicate with the UE in accordance with the beam information.

Some examples of the method, apparatuses, and non-transitory computer-readable medium described herein may further include operations, features, means, or instructions for receiving, via the first uplink message and based on satisfaction of the trigger condition, a request for a resource for communicating the second uplink message and transmitting, to the UE and in response to the request, an indication of the resource, where the second uplink message may be received within the resource.

Some examples of the method, apparatuses, and non-transitory computer-readable medium described herein may further include operations, features, means, or instructions for receiving the request via one or more bit fields within the first uplink message that may be associated with reporting CSI associated with the set of multiple beam groups.

Some examples of the method, apparatuses, and non-transitory computer-readable medium described herein may further include operations, features, means, or instructions for transmitting, to the UE via the control signaling, second control signaling, or both, an indication of a set of resources for communicating requests associated with reporting CSI by the UE, where the first uplink message may be received within a resource of the set of resources.

Some examples of the method, apparatuses, and non-transitory computer-readable medium described herein may further include operations, features, means, or instructions for receiving, via the first uplink message, an indication of a CSI report identifier associated with the measurement report, an indication of a first beam group identifier associated with the first beam group, or both, where receiving the second uplink message, transmitting the additional control signaling, or both, may be based on the CSI report identifier, the first beam group identifier, or both.

In some examples of the method, apparatuses, and non-transitory computer-readable medium described herein, the trigger condition may be satisfied based on a first beam quality metric associated with the first beam group satisfying a reference beam quality metric and receiving the first uplink message may be based on the trigger condition being satisfied.

In some examples of the method, apparatuses, and non-transitory computer-readable medium described herein, the trigger condition may be satisfied based on a set of multiple beam quality metrics associated with the set of multiple beam groups each satisfying a reference beam quality metric and receiving the first uplink message may be based on the trigger condition being satisfied.

Some examples of the method, apparatuses, and non-transitory computer-readable medium described herein may further include operations, features, means, or instructions for transmitting, to the UE, an activation of a set of multiple TCI states, where the reference beam quality metric includes a beam quality metric associated with one or more activated TCI states of the set of multiple TCI states.

Some examples of the method, apparatuses, and non-transitory computer-readable medium described herein may further include operations, features, means, or instructions for transmitting, via the control signaling, an indication of the reference beam quality metric.

In some examples of the method, apparatuses, and non-transitory computer-readable medium described herein, the first beam group includes a set of multiple beams and the first beam quality metric includes an average beam quality metric associated with the set of multiple beams, a minimum beam quality metric associated with the set of multiple beams, a maximum beam quality metric associated with the set of multiple beams, or any combination thereof.

Some examples of the method, apparatuses, and non-transitory computer-readable medium described herein may further include operations, features, means, or instructions for transmitting, via the control signaling, second control signaling, or both, an indication of a set of multiple reference signal sets and transmitting a set of multiple reference signals associated with the set of multiple reference signal sets using at least a subset of beam groups of the set of multiple beam groups, where the trigger condition may be satisfied based on the set of multiple reference signals.

In some examples of the method, apparatuses, and non-transitory computer-readable medium described herein, the set of multiple reference signal sets may be associated with one another and each reference signal set of the set of multiple reference signal sets includes periodic measurement resources, semi-persistent measurement resources, or both.

In some examples of the method, apparatuses, and non-transitory computer-readable medium described herein, the first uplink message includes a RACH message, an uplink control message, a MAC-CE message, or any combination thereof.

In some examples of the method, apparatuses, and non-transitory computer-readable medium described herein, the measurement report includes an indication of one or more measurements associated with the first beam group, the one or more measurements including an L1-RSRP measurement, an L1-SINRmeasurement, a PHR measurement, an MPE measurement, an L3-RSRP measurement, an L3-SINR measurement, or any combination thereof.

### BRIEF DESCRIPTION OF THE DRAWINGS

FIG. 1 illustrates an example of a wireless communications system that supports techniques for event-triggered beam group reporting in accordance with aspects of the present disclosure.

FIG. 2 illustrates an example of a wireless communications system that supports techniques for event-triggered beam group reporting in accordance with aspects of the present disclosure.

FIG. 3 illustrates an example of a process flow that supports techniques for event-triggered beam group reporting in accordance with aspects of the present disclosure.

FIGS. 4 and 5 show block diagrams of devices that support techniques for event-triggered beam group reporting in accordance with aspects of the present disclosure.

FIG. 6 shows a block diagram of a communications manager that supports techniques for event-triggered beam group reporting in accordance with aspects of the present disclosure.

FIG. 7 shows a diagram of a system including a device that supports techniques for event-triggered beam group reporting in accordance with aspects of the present disclosure.

FIGS. 8 and 9 show block diagrams of devices that support techniques for event-triggered beam group reporting in accordance with aspects of the present disclosure.

FIG. 10 shows a block diagram of a communications manager that supports techniques for event-triggered beam group reporting in accordance with aspects of the present disclosure.

FIG. 11 shows a diagram of a system including a device that supports techniques for event-triggered beam group reporting in accordance with aspects of the present disclosure.

FIGS. 12 through 15 show flowcharts illustrating methods that support techniques for event-triggered beam group reporting in accordance with aspects of the present disclosure.

### DETAILED DESCRIPTION

In some wireless communications systems, wireless devices (e.g., user equipments (UEs)) perform measurements on reference signals (e.g., channel state information reference signals (CSI-RSs)) received from the network, and transmit measurement reports (e.g., CSI reports) indicating the measurements, thereby enabling the network to determine channel conditions and determine which beams should be used for wireless communications with the UE. UEs may be configured to transmit CSI reports for particular beams at the UE when certain conditions are satisfied (e.g., event-triggered beam reporting). For example, a UE may transmit a CSI report for a respective beam at the UE (e.g., Rx beam) when the respective beam exhibits a quality which is greater than a threshold quality. Further, UEs may be configured to transmit measurement reports (CSI reports) for multiple beams and/or multiple beam groups (e.g., a beam group including multiple beams). However, conventional wireless communications systems currently do not support event-triggered CSI reporting for beam groups (e.g., event-triggered group-based CSI reporting).

Accordingly, aspects of the present disclosure are directed toward techniques for event-triggered beam group reporting. In particular, aspects of the present disclosure support signaling and other configurations which enable UEs to perform CSI reporting for beam groups (e.g., groups of multiple beams) upon a satisfaction of some trigger condition (e.g., event-triggered group-based CSI reporting). For example, a UE may receive a CSI reporting configuration for reporting CSI information for beam groups at the UE, where the CSI reporting configuration includes trigger conditions for group-based CSI reporting. Upon identifying a satisfaction of a trigger condition, the UE may transmit an uplink message (e.g., uplink control information (UCI) message, medium access control-control element (MAC-CE)) indicating the satisfaction of the trigger condition, and may subsequently transmit a second uplink message including a measurement report (e.g., CSI report) for at least one beam group that satisfied the trigger condition. The UE may then receive updated beam information from the base station in response to the measurement report, and may communicate using the updated beam information.

In some aspects, a trigger condition for group-based CSI reporting may be satisfied if (1) any beam group exhibits a quality that satisfies some threshold quality, and/or (2) if every beam group within a set of beam groups exhibits a respective quality that satisfies some threshold quality. In some cases, the trigger condition (e.g., threshold quality) may be explicitly indicated to the UE, determined implicitly by the UE, or both. For example, in some implementations, the UE may determine a threshold beam quality metric used to evaluate a satisfaction of trigger conditions for group-based CSI reporting based on activated transmission configuration indicator (TCI) states at the UE.

Aspects of the disclosure are initially described in the context of wireless communications systems. Additional aspects of the disclosure are described in the context of an example process flow: Aspects of the disclosure are further illustrated by and described with reference to apparatus diagrams, system diagrams, and flowcharts that relate to techniques for event-triggered beam group reporting.

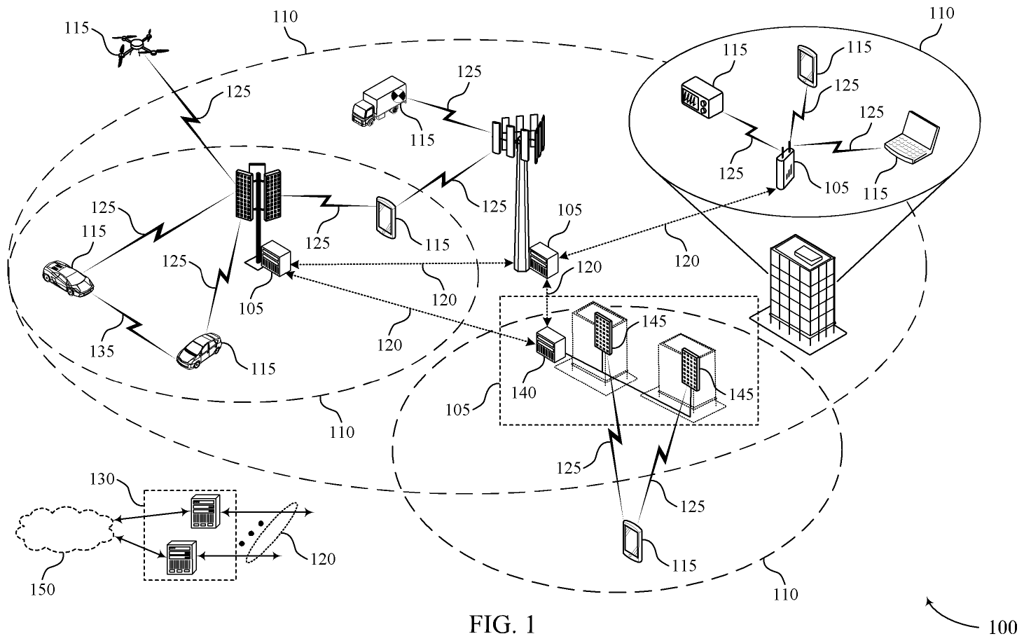

FIG. 1 illustrates an example of a wireless communications system 100 that supports techniques for event-triggered beam group reporting in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), highest signal-to-interference-plus-noise ratio (SINR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless devices (e.g., UEs 115, base stations 105) of the wireless communications system 100 may be configured to support techniques for event-triggered beam group reporting. In particular, the wireless communications system 100 may support signaling and other configurations which enable UEs 115 to perform CSI reporting for beam groups (e.g., groups of multiple beams) upon a satisfaction of some trigger condition (e.g., event-triggered group-based CSI reporting).

For example, a UE 115 of the wireless communications system 100 may receive a CSI reporting configuration (from a base station 105) for reporting CSI information for beam groups at the UE 115, where the CSI reporting configuration includes trigger conditions for group-based CSI reporting. Upon identifying a satisfaction of a trigger condition, the UE 115 may transmit an uplink message (e.g., UCI message, MAC-CE) indicating the satisfaction of the trigger condition, and may subsequently transmit a second uplink message including a measurement report (e.g., CSI report) for at least one beam group that satisfied the trigger condition. The UE 115 may then receive updated beam information from the base station in response to the measurement report, and may communicate using the updated beam information.

In some aspects, a trigger condition for group-based CSI reporting may be satisfied if (1) any beam group exhibits a quality that satisfies some threshold quality, and/or (2) if every beam group within a set of beam groups exhibits a respective quality that satisfies some threshold quality. In some cases, the trigger condition (e.g., threshold quality) may be explicitly indicated to the UE 115, determined implicitly by the UE 115, or both. For example, in some implementations, the UE 115 may determine a threshold beam quality metric used to evaluate a satisfaction of trigger conditions for group-based CSI reporting based on activated TCI states at the UE 115.

Techniques described herein may support improved CSI reporting at UEs 115. In particular, aspects of the present disclosure may enable UEs 115 to perform event-triggered group-based CSI reporting. That is, techniques described herein may enable UEs 115 to transmit CSI reports (and other measurement reports) for groups of multiple beams upon a satisfaction of one or more trigger conditions. In this regard, aspects of the present disclosure may enable UEs 115 to report CSI information for multiple beam groups in cases where the UE 115 identifies that a current beam group exhibits poor quality, when the UE 115 identifies other beam groups which exhibit higher quality than a current beam group, or both. As such, techniques described herein may facilitate improved CSI information exchange between the UE 115 and the network, thereby providing improved channel quality information at the network and more efficient, reliable wireless communications.

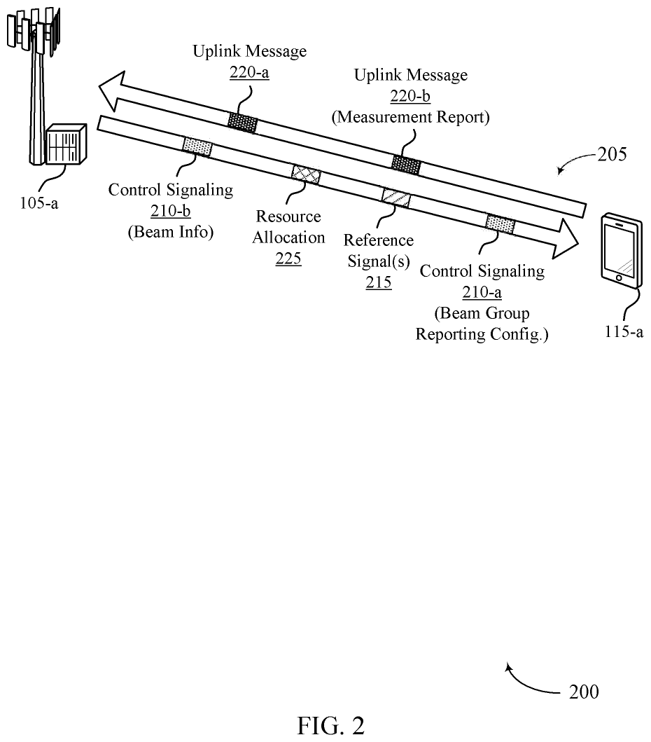

FIG. 2 illustrates an example of a wireless communications system 200 that supports techniques for event-triggered beam group reporting in accordance with aspects of the present disclosure. In some examples, wireless communications system 200 may implement, or be implemented by, aspects of wireless communications system 100. The wireless communications system 200 may include a base station 105-a and a UE 115-a, which may be examples of base stations 105 and UEs 115 described herein with reference to FIG. 1.

The UE 115-a may communicate with the base station 105-a using one or more communication links 205. For example, the UE 115-a may communicate with the base station 105-a via a communication link 205, which may include an example of an access link (e.g., Uu link). The communication link 205 may include a bi-directional link that can include both uplink and downlink communication. For example, the UE 115-a may transmit uplink transmissions, such as uplink control signals or uplink data signals, to the base station 105-a via communication link 205, and the base station 105-a may transmit downlink transmissions, such as downlink control signals or downlink data signals, to the UE 115-a via the communication link 205.

As noted previously herein, in some wireless communications systems, wireless devices (e.g., UEs 115) may perform measurements on reference signals (e.g., CSI-RSs) received from the network, and transmit measurement reports (e.g., CSI reports) indicating the measurements, thereby enabling the network to determine channel conditions and determine which beams should be used for wireless communications with the UE 115. UEs 115 may be configured to transmit CSI reports for particular beams at the UE 115 when certain conditions are satisfied (e.g., event-triggered beam reporting), and/or may transmit CSI reports for multiple beams and/or multiple beam groups (e.g., a beam group including multiple beams).

For example, a UE 115 may transmit a CSI report for a respective beam at the UE 115 (e.g., Rx beam) when the respective beam exhibits a quality which is greater than a threshold quality. Some wireless communications systems support different alternatives for multi-beam measurement/reporting for inter-cell beam management and inter-cell multi transmission reception point (mTRP). In accordance with a first alternative, UEs 115 may support Layer 1 (L1) based event-driven beam reporting for inter-cell beam management and inter-cell mTRP. In accordance with a second alternative, UEs 115 may support MAC-CE based event-driven beam reporting for inter-cell beam management and inter-cell mTRP. Comparatively, in some wireless communications systems, event-driven beam reporting may not be supported for inter-cell beam management and inter-cell mTRP.

For beam measurement in support of mTRP simultaneous transmission in the context of the first alternative (e.g., L1-based event-driven beam reporting), UEs 115 may transmit a single CSI report including measurements for N beam pairs/beam groups, with M (M>1) beams per beam pair/beam group, where different beams within a beam pair/beam group may be received simultaneously, and where a beam index is represented by a CSI reference resource index or a synchronization signal block (SSB) index. UEs 115 may support CSI reporting with two or more beams per beam group (e.g., support M=2), and may transmit CSI reports for two or more beam groups (e.g., N=1, 2, 3, . . . , etc.). In such cases, L1-based CSI reports may include L1-reference signal received power (L1-RSRP) measurements for reported beam groups, L1-SINR measurements for reported beam groups, or both.

In the context of the second alternative for CSI reporting (e.g., MAC-CE-based event-driven beam reporting), the maximum number of beam pairs/beam groups (e.g., maximum value of N) that may be reported in a single CSI-report may be one, two, three, four, etc. (e.g., N={1, 2}, or N={1, 2, 3, 4}). In some cases, the maximum value of beam pairs/beam groups (e.g., maximum value of N) may be based on UE capability (e.g., N_{cap}), fixed by the network (e.g., via RRC configuration), or both. In additional or alternative implementations, the maximum value of N may be upper bounded by a maximum value (Nₘₐₓ) configured via RRC signaling, and may be dynamically selected/indicated by UE 115.

However, conventional wireless communications systems currently do not support event-triggered CSI reporting for beam groups (e.g., event-triggered group-based CSI reporting). That is, conventional wireless communications systems do not extend event-triggered beam reporting for beam group-based CSI reports. In other words, UEs 115 in some conventional wireless communications systems are unable to transmit CSI reports for beam groups including multiple beams in response to some event or satisfaction of some trigger condition.

Accordingly, the respective devices of the wireless communications system 200 may support techniques for event-triggered beam group reporting. In particular, the wireless communications system 200 may support signaling and other configurations which enable the UE 115-a to perform CSI reporting for beam groups (e.g., groups of multiple beams) upon a satisfaction of some trigger condition (e.g., event-triggered group-based CSI reporting). That is, techniques described herein may enable the UE 115-a of the wireless communications system 200 to transmit CSI reports (and other measurement reports) for groups of multiple beams upon a satisfaction of one or more trigger conditions. As such, techniques described herein may facilitate improved CSI information exchange between the UE 115-a and the base station 105-a, thereby providing improved channel quality information at the network and more efficient, reliable wireless communications.

For example, as shown in FIG. 2, the UE 115-a may receive, from the base station 105-a, control signaling 210-a (e.g., RRC signaling, system information messaging, or MAC-CE indication) indicating a beam group reporting configuration for event-triggered group-based CSI reporting. That is, the UE 115-a may be configured with a beam group reporting configuration including one or more trigger conditions for reporting CSI information associated with multiple beam groups at the UE 115-a in a single CSI reporting instance, where each respective beam group includes multiple beams. In some cases, each beam may include a Tx beam at the base station 105-a and an Rx beam at the UE 115-a, which is identified by a CSI-RS resource index (CSI-RI) or SSB index. For instance, a beam group may include two beam indexes included in the beam group (e.g., a BeamGroup=(CSI-RS₁, CSI-RS₂)).

In some aspects the beam group reporting configuration may include (and/or indicate) one or more trigger conditions for transmitting measurement reports associated with beam groups at the UE 115-a. That is, the beam group reporting configuration may indicate trigger condition(s) which, if satisfied, cause the UE 115-a to transmit CSI reports. Trigger conditions may include any condition or metric at the UE 115-a, within the network, or both, that may be used to trigger group-based CSI reporting by the UE 115-a, including reference beam quality metrics, quality of service (QOS) requirements, and the like. Reference beam quality metrics used for evaluating a satisfaction (or lack thereof) of trigger conditions for CSI reporting may be explicitly signaled by the base station 105-a (e.g., via control signaling 210-a), determined based on activated TCI states at the UE 115-a, or both.

For example, the control signaling 210-a may indicate a reference beam quality metric which, if satisfied by a beam group, causes the UE 115-a to transmit a CSI report for the respective beam group. For instance, in cases where the control signaling 210-a indicates a reference beam quality metric, the UE 115-a may be configured to transmit a measurement report (e.g., CSI report) for a beam group if the beam group exhibits a quality which is greater than or equal to the reference beam quality metric. The reference beam quality metric may include any quality metric including, but not limited to, RSRP, RSRQ, RSSI, SNR, SINR, CQI, and the like.

The control signaling 210-a may indicate additional or alternative information associated with the beam group reporting configuration for event-triggered group-based CSI reporting. Other information which may be indicated/configured by the control signaling 210-a may include resources used to transmit requests for resources for CSI reports, set(s) of reference signals 215 used to perform group-based CSI reporting, and the like. For example, in some aspects, the control signaling 210-a may indicate sets of resources which are usable by the UE 115-a for indicating when a trigger condition for group-based CSI reporting has been satisfied. That is, the control signaling 210-a may configure the UE 115-a with pre-configured resources which may be used by the UE 115-a to report when a trigger condition has been satisfied, and to request resources for transmitting event-triggered CSI reports for beam groups.

By way of another example, the control signaling 210-a may indicate one or more reference signal 215 sets (e.g., CSI-RS sets) which are to be monitored by the UE 115-a for CSI reporting. For instance, the control signaling 210-a may indicate multiple CSI-RS sets that are associated with one another (related), where each CSI-RS set includes reference signals 215/resources (e.g., periodic channel measurement resources, semi-persistent channel measurement resources) which are to be monitored/measured by the UE 115-a for event-triggered group-based CSI reporting. In this regard, the UE 115-a may be configured with multiple channel measurement resource sets to detect event(s) for beam group-based CSI reporting. In such cases, the multiple channel measurement resource sets may be RRC-associated with one another, and may include RRC-configured resource sets that are periodic and/or semi-persistent.

In some aspects, the UE 115-a may receive one or more reference signals 215 (e.g., CSI-RSs) from the base station 105-a. The UE 115-a may receive, and the base station 105-a may transmit, the reference signals 215 based on receiving/transmitting the control signaling 210-a. For example, in some cases, the UE 115-a may receive one or more reference signals 215 associated with the one or more reference signal 215 sets (e.g., CSI-RS sets) which were indicated/configured via the control signaling 210-a.

In some aspects, the UE 115-a may receive the reference signal(s) 215 (and the base station 105-a may transmit the reference signals 215) using one more beam groups. For example, in some cases, the base station 105-a may cycle through Tx beams of the respective beam groups, and the UE 115-a may cycle through Rx beams of the respective beam groups, such that the respective reference signals 215 are transmitted/received in accordance with different beam groups. In this regard, the UE 115-a may be configured to perform measurements for the respective reference signals 215 associated with the respective beam groups in order to evaluate beam quality metrics for the respective beam groups. In some cases, the UE 115-a may be configured to perform measurements with a currently-active beam group, as well as other, inactive beam groups, in order to evaluate which beam group(s) should be used for wireless communications between the UE 115-a and the base station 105-a.

In some implementations, the UE 115-a may identify a satisfaction of one or more trigger conditions of the beam group reporting configuration. That is, the UE 115-a may identify that a trigger condition for group-based CSI reporting (e.g., event-triggered group-based CSI reporting) has been satisfied. The UE 115-a may identify the satisfaction of one or more trigger conditions based on receiving the control signaling 210-a, receiving the reference signals 215, or both. In some cases, the UE 115-b may trigger a beam group-based CSI report when an event condition is achieved (e.g., when a trigger condition is satisfied).

In some implementations, the UE 115-a may identify a satisfaction of a trigger condition for group-based CSI reporting if a beam quality of at least one beam group is better than a reference beam quality. For example, the UE 115-a may identify that a trigger condition for group-based CSI reporting has been satisfied based on a first beam quality metric associated with a first beam group satisfying a reference beam quality metric. In such cases, a single beam group may be sufficient to satisfy a trigger condition. In additional or alternative implementations, the UE 115-a may identify a satisfaction of a trigger condition for group-based CSI reporting if a beam quality of all beam groups is better than a reference beam quality. For example, the UE 115-a may identify that a trigger condition for group-based CSI reporting has been satisfied based on a beam quality metrics associated with each beam group of a set of beam groups satisfying a reference beam quality metric (e.g., all beam groups must satisfy reference beam quality metric to trigger group-based CSI reporting).

In additional or alternative implementations, the UE 115-a may identify a satisfaction of a trigger condition when an inactive beam group exhibits a beam quality metric which exceeds a beam quality metric of an active beam group that is currently being used for wireless communications between the UE 115-a and the base station 105-a.

Beam quality metrics for the respective beam groups may be determined based on measurements preformed on reference signals 215 (e.g., reference signal 215 sets) which were transmitted/received in accordance with the respective beam groups. Additionally, or alternatively, beam quality metrics for respective beam groups may be measured by filtering multiple measurement samples. Beam quality metrics of the respective beam groups may be determined as a minimum of beam quality metrics of the beams within each beam group, a maximum of beam quality metrics of the beams within each beam group, an average or median beam quality metric of the beams within each beam group, and the like. For example, for a first beam group including a first beam and a second beam, the UE 115-a may determine a beam quality metric as a minimum, maximum, average, and/or mean beam quality metric from a first beam quality metric for the first beam and a second beam quality metric for the second beam.

The reference beam quality metric may be associated with any quality metric (e.g., threshold RSRP, RSRQ, SNR, SINR, CQI). Moreover, the reference beam quality metric may be defined as an absolute value or a pre-configured threshold offset. As noted previously herein, the reference beam quality metric may be explicitly signaled/configured via the control signaling 210-a, determined based on activated TCI states at the UE 115-a, or both. For example, in some cases, the control signaling 210-a may explicitly indicate the beam quality threshold (e.g., pre-configured RSRP threshold). By way of another example, in some cases, the control signaling 210-a may include/indicate an activation of one or more TCI states at the UE 115-a. In this example, the reference beam quality metric may be associated with (or determined based on) the one or more activated TCI states, or a subset of the activated TCI states. In such cases, the beam quality threshold may include a beam quality of any pairs of TCI states activated by a TCI activation MAC-CE message, a beam quality of all pairs of TCI states activated by a TCI activation MAC-CE message, or both.

In some aspects, the UE 115-b may first indicate a request of beam-group based CSI reporting, and may then report the beam report. For example, as shown in FIG. 2, the UE 115-a may transmit a first uplink message 220-a in accordance with the beam group reporting configuration, where the first uplink message 220-a indicates that one or more trigger conditions for group-based CSI reporting have been satisfied. In this regard, the UE 115-a may transmit the first uplink message 220-a based on receiving the control signaling 210-a, receiving the reference signal(s) 215, identifying the satisfaction of one or more trigger conditions for group-based CSI reporting, or any combination thereof. The first uplink message 220-a may include a UCI message, a MAC-CE message, a random access channel message, or any combination thereof.

In some aspects, the first uplink message 220-a may include a request for resources for communicating measurement reports for one or more beam groups. In other words, the first uplink message 220-a may include a request for resources that may be used to transmit a group-based CSI report. In such cases, the UE 115-a may transmit the request via one or more bit fields of the first uplink message 220-a that are associated with reporting CSI information for the respective beam groups. In other words, the UE 115-a may communicate the request via one or more bit fields which are dedicated for (e.g., associated with) event-triggered group-based CSI reporting.

For example, the first uplink message 220-a may include a single-bit event indicator, such as a single-bit scheduling request in the context of PUCCH scheduling request (PUCCH-SR) messages, physical random access channel (PRACH) messages, or both. By way of another example, the first uplink message 220-a may include a multi-bit event indicator in cases where the first uplink message 220-a includes a UCI message transmitted via PUCCH or PUSCH, and/or a MAC-CE transmitted via PUSCH. For instance, the UE 115-b may be configured (e.g., via control signaling 210-a) with periodic PUCCH occasions for transmitting UCI messages including multi-bit event indicators indicating satisfaction of trigger conditions. In this example, the UCI message (e.g., first uplink message 220-a) may indicate a CSI report configuration ID associated with the CSI report.

In some implementations, the UE 115-a may transmit the first uplink message 220-a within pre-configured resources. For example, in cases where the control signaling 210-a indicates/configures resources usable by the UE 115-a for transmitting requests for CSI reporting resources, the UE 115-a may transmit the first uplink message 220-a within the resources configured via the control signaling 210-a.

In some aspects, the first uplink message 220-a may indicate which beam group(s) satisfied the trigger condition(s) (e.g., beam group identifiers), CSI report identifiers associated with a group-based CSI report that is to be transmitted by the UE 115-a, or both. For example, upon determining that a first beam group satisfies a trigger condition for group-based beam reporting, the first uplink message 220-a may include a beam group ID associated with the first beam group, a CSI report ID associated with a CSI report configuration for reporting CSI information for the first beam group, or both.

In some aspects, the UE 115-a may receive, from the base station 105-a, a resource allocation 225 for transmitting a measurement report (e.g., resource for transmitting a CSI report). In some cases, the UE 115-a may receive, and the base station 105-a may transmit, the resource allocation 225 based on (e.g., in response to) transmitting/receiving the first uplink message 220-a. In particular, the base station 105-a may transmit the resource allocation 225 in response to the first uplink message 220-a including a request for resources for communicating group-based CSI reports.

The UE 115-a may transmit a second uplink message 220-b including a measurement report (e.g., CSI report) that includes CSI information for the one or more beam groups associated with the satisfaction of the trigger condition. The UE 115-a may transmit the second uplink message 220-b based on receiving the control signaling 210-a, receiving the reference signal(s) 215, identifying the satisfaction of the trigger condition(s), transmitting the first uplink message 220-a, receiving the resource allocation 225, or any combination thereof. For example, in some aspects, the UE 115-a may transmit the second uplink message 220-b within the resources indicated via the resource allocation 225.

The measurement report may include CSI information associated with at least one beam group that was determined to satisfy the trigger condition for group-based beam reporting. For example, in cases where the UE 115-a identifies that a first beam group satisfies the trigger condition, the measurement report may include measurements (e.g., CSI information) for at least the first beam group. Measurements/CSI information for reported beam groups may include, but is not limited to, RSRP measurements (e.g., L1-RSRP, L3-RSRP), SINR measurements (e.g., L1-SINR, L3-SINR), power headroom (PHR) measurements, maximum permissible exposure (MPE) measurements, or any combination thereof. In this regard, techniques for event-triggered group-based beam reporting described herein may be applied to group-based CSI reports including L1 metrics (e.g., L1-RSRP, L1-SINR), L2 metrics (e.g., PHR, modified PHR including the impact of MPE values, or MPE values), L3 metrics (e.g., (e.g., L3-RSRP, L3-SINR), or any combination thereof.

In some implementations, the measurement report (e.g., measurement report included within the second uplink message 220-b) may include CSI information only for beam group(s) which satisfy the trigger condition. That is, only beam groups which satisfy the trigger condition may be reported via the measurement report. For example, in cases where the first uplink message 220-a includes a first beam group ID for a first beam group which satisfies the trigger condition, the measurement report may include CSI information associated with the first beam group/first beam group ID. Moreover, the measurement report may include (or be associated with) a CSI report configuration ID indicated via the first uplink message 220-a. In additional or alternative implementations, the measurement report may include CSI information for all beam groups (or a subset of beam groups), including beam groups which do not satisfy the respective trigger conditions.

In some aspects, the UE 115-a may receive, from the base station 105-a, additional control signaling 210-b that indicates beam information (e.g., updated beam information) for communications between the UE 115-a and the base station 105-a. The additional control signaling 210-b may include RRC signaling, DCI signaling, MAC-CE signaling, or any combination thereof. In some cases, the UE 115-a may receive, and the base station 105-a may transmit, the additional control signaling 210-b based on (in response to) the second uplink message 220-b including the measurement report (e.g., CSI report). In particular, the additional control signaling 210-b may indicate which beam group(s) will be used for subsequent communications between the UE 115-a and the base station 105-a.

For example, in cases where the measurement report indicates that a first beam group satisfies the trigger condition (e.g., first beam group exhibits a beam quality metric which exceeds some reference beam threshold metric), the additional control signaling 210-b may instruct the UE 115-a to perform subsequent communications with the base station 105-a in accordance with (e.g., using) the first beam group.

The UE 115-a, the base station 105-a, or both, may perform one or more beam switching procedures. In particular, the UE 115-a and/or the base station 105-a may perform one or more beam switching procedures based on (e.g., in accordance with) the beam information indicated via the additional control signaling 210-b. For example, the additional control signaling 210-b may indicate that subsequent communications between the UE 115-a and the base station 105-a are to be performed using a first beam group including a first beam and a second beam which can be received simultaneously at the UE 115-b. In this example, the UE 115-a may perform a beam switching procedure from a current group of Rx beams to the first group of Rx beams associated with the first beam group, and the base station 105-a may perform a beam switching procedure from a current group of Tx beams to the first group of Tx beams associated with the first beam group.

Subsequently, the UE 115-a, the base station 105-a, or both, may communicate with one another in accordance with the beam information indicated via the additional control signaling 210-b. Moreover, the UE 115-a and the base station 105-a may perform communications with one another based on performing the one or more beam switching procedures. For example, in cases where the UE 115-a and/or the base station 105-a perform beam switching procedures to respective beams of a first beam group, the UE 115-a and the base station 105-a may then communicate with one another (e.g., transmit uplink and/or downlink messages) using the first beam group.

Techniques described herein may support improved CSI reporting at the UE 115-a. In particular, aspects of the present disclosure may enable the UE 115-a to perform event-triggered group-based CSI reporting. That is, techniques described herein may enable the UE 115-a to transmit CSI reports (and other measurement reports) for groups of multiple beams upon a satisfaction of one or more trigger conditions. In this regard, aspects of the present disclosure may enable the UE 115-a to report CSI information for multiple beam groups in cases where the UE 115-a identifies that a current beam group exhibits poor quality, when the UE 115-a identifies other beam groups which exhibit higher quality than a current beam group, or both. As such, techniques described herein may facilitate improved CSI information exchange between the UE 115-a and the base station 105-a, thereby providing improved channel quality information at the network and more efficient, reliable wireless communications.

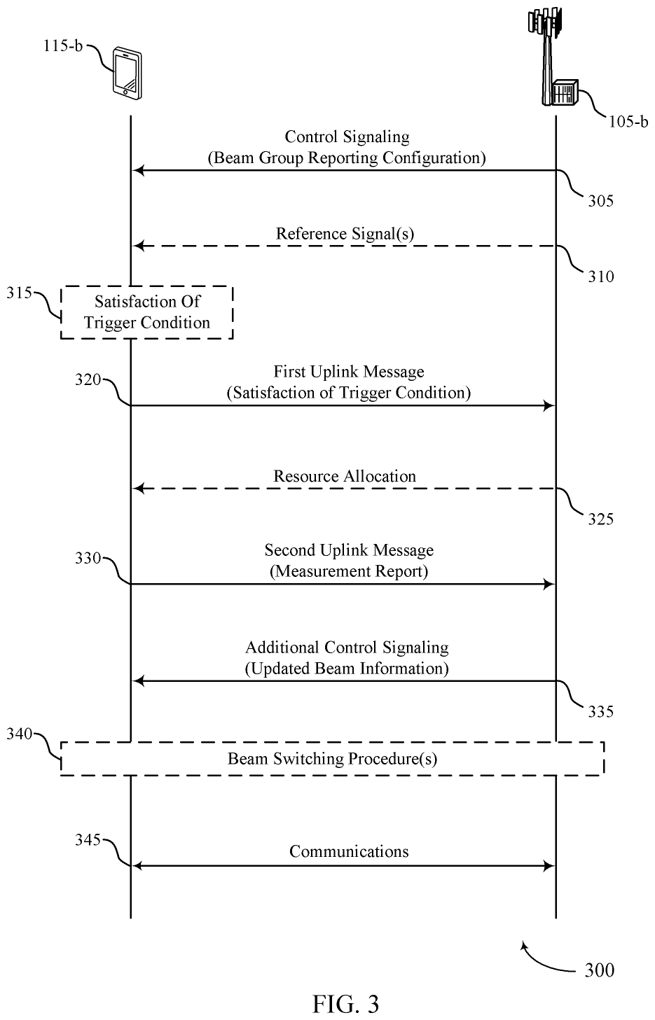

FIG. 3 illustrates an example of a process flow 300 that supports techniques for event-triggered beam group reporting in accordance with aspects of the present disclosure. In some examples, process flow 300 may implement, or be implemented by, aspects of wireless communications system 100, wireless communications system 200, or both. In particular, the process flow 300 techniques for event-triggered group-based CSI reporting, as described as described herein with reference to FIGS. 1-2, among other aspects.

The process flow 300 may include a UE 115-b and a base station 105-b, which may be examples of UEs 115 and base stations 105 as described herein with reference to FIGS. 1-2. For example, the UE 115-b and the base station 105-b illustrated in FIG. 3 may be examples of the UE 115-a and the base station 105-a, respectively, as illustrated in FIG. 2.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 305, the UE 115-b may receive, from the base station 105-b, control signaling (e.g., RRC signaling, system information messaging, MAC-CE indication) indicating a beam group reporting configuration for event-triggered group-based CSI reporting. That is, the UE 115-b may be configured with a beam group reporting configuration including one or more trigger conditions for reporting CSI information associated with multiple beam groups at the UE 115-b, where each respective beam group includes multiple beams. In some cases, each beam may include a Tx beam at the base station 105-b and an Rx beam at the UE 115-b, which is represented by a CSI-RS resource index (CSI-RI) or a SSB resource index. For instance, a beam group may include a first beam and a second beam which can be received simultaneously (e.g., BeamGroup₁=(CSI-RS_{1A}, CSI-RS_{1B})), and a second beam group may include a first beam and a fourth beam (e.g., BeamGroup₂=(CSI-RS_{2A}, CSI-RS_{2B})) which can be received simultaneously.

In some aspects the beam group reporting configuration may include (and/or indicate) one or more trigger conditions for transmitting measurement reports associated with beam groups at the UE 115-b. That is, the beam group reporting configuration may indicate trigger condition(s) which, if satisfied, cause the UE 115-b to transmit CSI reports. Trigger conditions may include any condition or metric at the UE 115-b, within the network, or both, that may be used to trigger group-based CSI reporting by the UE 115-b, including reference beam quality metrics, QoS requirements, and the like. Reference beam quality metrics used for evaluating a satisfaction (or lack thereof) of trigger conditions for CSI reporting may be explicitly signaled by the base station 105-b (e.g., via control signaling at 305), determined based on activated TCI states at the UE 115-b, or both.

For example, the control signaling may indicate a reference beam quality metric which, if satisfied by a beam group, causes the UE 115-b to transmit a CSI report for the respective beam group. For instance, in cases where the control signaling indicates a reference beam quality metric, the UE 115-b may be configured to transmit a CSI report for a beam group if the beam group exhibits a quality which is greater than or equal to the reference beam quality metric. The reference beam quality metric may include any quality metric including, but not limited to, RSRP, RSRQ, RSSI, SNR, SINR, CQI, and the like.

The control signaling may indicate additional or alternative information associated with the beam group reporting configuration for event-triggered group-based CSI reporting. Other information which may be indicated/configured by the control signaling may include resources used to transmit requests for resources for CSI reports, set(s) of reference signals used to perform group-based CSI reporting, and the like. For example, in some aspects, the control signaling may indicate sets of resources which are usable by the UE 115-b for indicating when a trigger condition for group-based CSI reporting has been satisfied. That is, the control signaling may configure the UE 115-b with pre-configured resources which may be used by the UE 115-b to report when a trigger condition has been satisfied, and to request resources for transmitting event-triggered CSI reports for beam groups.

By way of another example, the control signaling may indicate one or more reference signal sets (e.g., CSI-RS sets) which are to be monitored by the UE 115-b for CSI reporting. For instance, the control signaling may indicate multiple CSI-RS sets that are associated with one another (related), where each CSI-RS set includes reference signals/resources (e.g., periodic channel measurement resources, semi-persistent channel measurement resources) which are to be monitored/measured by the UE 115-b for event-triggered group-based CSI reporting.

At 310, the UE 115-b may receive one or more reference signals (e.g., CSI-RSs) from the base station 105-b. The UE 115-b may receive, and the base station 105-b may transmit, the reference signals at 310 based on receiving/transmitting the control signaling at 305. For example, in some cases, the UE 115-b may receive one or more reference signals associated with the one or more reference signal sets (e.g., CSI-RS sets) which were indicated/configured via the control signaling at 305.

In some aspects, the UE 115-b may receive the reference signal(s) (and the base station 105-b may transmit the reference signals) using one more beam groups. For example, in some cases, the base station 105-b may cycle through transmit beams of the respective beam groups, and the UE 115-b may cycle through receive beams of the respective beam groups, such that the respective reference signals are transmitted/received in accordance with different beam groups. In this regard, the UE 115-b may be configured to perform measurements for the respective reference signals associated with the respective beam groups in order to evaluate beam quality metrics for the respective beam groups. In some cases, the UE 115-b may be configured to perform measurements with a currently-active beam group, as well as other, inactive beam groups, in order to evaluate which beam group(s) should be used for wireless communications between the UE 115-b and the base station 105-b.

At 315, the UE 115-b may identify a satisfaction of one or more trigger conditions of the beam group reporting configuration. That is, the UE 115-b may identify that a trigger condition for group-based CSI reporting (e.g., event-triggered group-based CSI reporting) has been satisfied. The UE 115-b may identify the satisfaction of one or more trigger conditions based on receiving the control signaling at 305, receiving the reference signals at 310, or both.

In some implementations, the UE 115-b may identify a satisfaction of a trigger condition for group-based CSI reporting if a beam quality of at least one beam group is better than a reference beam quality. For example, the UE 115-b may identify that a trigger condition for group-based CSI reporting has been satisfied based on a first beam quality metric associated with a first beam group satisfying a reference beam quality metric. In such cases, a single beam group may be sufficient to satisfy a trigger condition. In additional or alternative implementations, the UE 115-b may identify a satisfaction of a trigger condition for group-based CSI reporting if a beam quality of all beam groups is better than a reference beam quality. For example, the UE 115-b may identify that a trigger condition for group-based CSI reporting has been satisfied based on a beam quality metrics associated with each beam group of a set of beam groups satisfying a reference beam quality metric (e.g., all beam groups must satisfy reference beam quality metric to trigger group-based CSI reporting).

In additional or alternative implementations, the UE 115-b may identify a satisfaction of a trigger condition when an inactive beam group exhibits a beam quality metric which exceeds a beam quality metric of an active beam group that is currently being used for wireless communications between the UE 115-b and the base station 105-b.

Beam quality metrics for the respective beam groups may be determined based on measurements preformed on reference signals (e.g., reference signal sets) which were transmitted/received in accordance with the respective beam groups. Beam quality metrics of the respective beam groups may be determined as a minimum of beam quality metrics of the beams within each beam group, a maximum of beam quality metrics of the beams within each beam group, an average or median beam quality metric of the beams within each beam group, and the like. For example, for a first beam group including a first beam and a second beam, the UE 115-b may determine a beam quality metric as a minimum, maximum, average, and/or mean beam quality metric from a first beam quality metric for the first beam and a second beam quality metric for the second beam.

As noted previously herein, the reference beam quality metric may be explicitly signaled/configured via the control signaling at 305, determined based on activated TCI states at the UE 115-b, or both. For example, in some cases, the control signaling may include/indicate an activation of one or more TCI states at the UE 115-b. In this example, the reference beam quality metric may be associated with (or determined based on) the one or more activated TCI states, or a subset of the activated TCI states.

At 320, the UE 115-b may transmit a first uplink message in accordance with the beam group reporting configuration, where the first uplink message indicates that one or more trigger conditions for group-based CSI reporting have been satisfied. In this regard, the UE 115-b may transmit the first uplink message at 320 based on receiving the control signaling at 305, receiving the reference signal(s) at 310, identifying the satisfaction of one or more trigger conditions for group-based CSI reporting at 315, or any combination thereof. The first uplink message may include a UCI message, a MAC-CE message, a random access channel message, or any combination thereof.

In some aspects, the first uplink message may include a request for resources for communicating measurement reports for one or more beam groups. In other words, the first uplink message may include a request for resources that may be used to transmit a group-based CSI report. In such cases, the UE 115-b may transmit the request via one or more bit fields of the first uplink message that are associated with reporting CSI information for the respective beam groups. In other words, the UE 115-b may communicate the request via one or more bit fields which are dedicated for (e.g., associated with) event-triggered group-based CSI reporting. In some implementations, the UE 115-b may transmit the first uplink message within pre-configured resources. For example, in cases where the control signaling indicates/configures resources usable by the UE 115-b for transmitting requests for CSI reporting resources, the UE 115-b may transmit the first uplink message within the resources configured via the control signaling at 305.

In some aspects, the first uplink message may indicate which beam group(s) satisfied the trigger condition(s) (e.g., beam group identifiers), CSI report identifiers associated with a group-based CSI report that is to be transmitted by the UE 115-b, or both. For example, upon determining that a first beam group satisfies a trigger condition at 315, the first uplink message may include a beam group ID associated with the first beam group, a CSI report configuration ID associated with a CSI report configuration for reporting CSI information for the first beam group, or both.

At 325, the UE 115-b may receive, from the base station 105-b, a resource allocation for transmitting a measurement report (e.g., resource for transmitting a CSI report). In some cases, the UE 115-b may receive, and the base station 105-b may transmit, the resource allocation at 325 based on (e.g., in response to) transmitting/receiving the first uplink message at 320. In particular, the base station 105-b may transmit the resource allocation in response to the first uplink message including a request for resources for communicating group-based CSI reports.

At 330, the UE 115-b may transmit a second uplink message including a measurement report (e.g., CSI report) that includes CSI information for the one or more beam groups associated with the satisfaction of the trigger condition. The UE 115-b may transmit the second uplink message based on receiving the control signaling at 305, receiving the reference signal(s) at 310, identifying the satisfaction of the trigger condition(s) at 315, transmitting the first uplink message at 320, receiving the resource allocation at 325, or any combination thereof. For example, in some aspects, the UE 115-b may transmit the second uplink message within the resources indicated via the resource allocation at 325.

The measurement report may include CSI information associated with at least one beam group that was determined to satisfy the trigger condition at 315. For example, in cases where the UE 115-b identifies that a first beam group satisfies the trigger condition, the measurement report may include measurements (e.g., CSI information) for at least the first beam group. Measurements/CSI information for reported beam groups may include, but is not limited to, RSRP measurements (e.g., L1-RSRP, L3-RSRP), SINR measurements (e.g., L1-SINR, L3-SINR), PHR measurements, MPE measurements, or any combination thereof.

In some implementations, the measurement report may include CSI information only for beam group(s) which satisfy the trigger condition. That is, only beam groups which satisfy the trigger condition may be reported via the measurement report at 330. For example, in cases where the first uplink message includes a first beam group ID for a first beam group which satisfies the trigger condition, the measurement report may include CSI information associated with the first beam group/first beam group ID. Moreover, the measurement report may include (or be associated with) a CSI report configuration ID indicated via the first uplink message. In additional or alternative implementations, the measurement report may include CSI information for all beam groups (or a subset of beam groups), including beam groups which do not satisfy the respective trigger conditions.

At 335, the UE 115-b may receive, from the base station 105-b, additional control signaling that indicates beam information (e.g., updated beam information) for communications between the UE 115-b and the base station 105-b. The additional control signaling may include RRC signaling, DCI signaling, MAC-CE signaling, or any combination thereof. In some cases, the UE 115-b may receive, and the base station 105-b may transmit, the additional control signaling based on (in response to) the second uplink message including the measurement report (e.g., CSI report). In particular, the additional control signaling may indicate which beam group(s) will be used for subsequent communications between the UE 115-b and the base station 105-b.

For example, in cases where the measurement report indicates that a first beam group satisfies the trigger condition (e.g., first beam group exhibits a beam quality metric which exceeds some reference beam threshold metric), the additional control signaling may instruct the UE 115-b to perform subsequent communications with the base station 105-b in accordance with (e.g., using) the first beam group.

At 340, the UE 115-b, the base station 105-b, or both, may perform one or more beam switching procedures. In particular, the UE 115-b and/or the base station 105-b may perform one or more beam switching procedures based on (e.g., in accordance with) the beam information indicated via the additional control signaling at 335. For example, the additional control signaling may indicate that subsequent communications between the UE 115-b and the base station 105-b are to be performed using a first beam group including a first beam and a second beam which can be received simultaneously at the UE 115-b. In this example, the UE 115-b may perform a beam switching procedure from a current group of Rx beams to the first group of Rx beams associated with the first beam group, and the base station 105-b may perform a beam switching procedure from a current group of Tx beams to the first group of Tx beams associated with the first beam group.

At 345, the UE 115-b, the base station 105-b, or both, may communicate with one another in accordance with the beam information indicated via the additional control signaling at 335. Moreover, the UE 115-b and the base station 105-b may perform communications with one another based on performing the one or more beam switching procedures at 340. For example, in cases where the UE 115-a and/or the base station 105-b perform beam switching procedures to respective beams of a first beam group, the UE 115-b and the base station 105-b may then communicate with one another (e.g., transmit uplink and/or downlink messages) using the first beam group.

Techniques described herein may support improved CSI reporting at the UE 115-b. In particular, aspects of the present disclosure may enable the UE 115-b to perform event-triggered group-based CSI reporting. That is, techniques described herein may enable the UE 115-b to transmit CSI reports (and other measurement reports) for groups of multiple beams upon a satisfaction of one or more trigger conditions. In this regard, aspects of the present disclosure may enable the UE 115-b to report CSI information for multiple beam groups in cases where the UE 115-b identifies that a current beam group exhibits poor quality, when the UE 115-b identifies other beam groups which exhibit higher quality than a current beam group, or both. As such, techniques described herein may facilitate improved CSI information exchange between the UE 115-b and the base station 105-b, thereby providing improved channel quality information at the network and more efficient, reliable wireless communications.

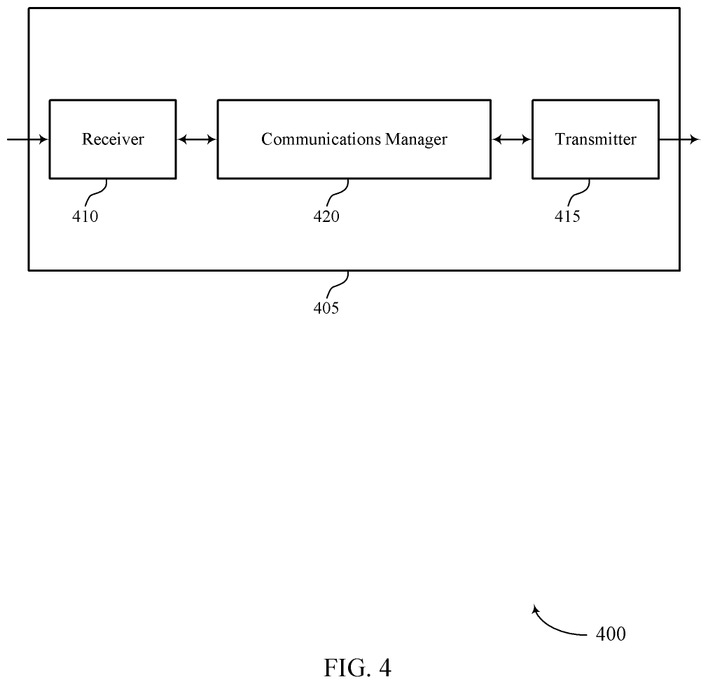

FIG. 4 shows a block diagram 400 of a device 405 that supports techniques for event-triggered beam group reporting in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for event-triggered beam group reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for event-triggered beam group reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for event-triggered beam group reporting as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for receiving, from a base station, control signaling indicating a beam group reporting configuration that includes a trigger condition for reporting, by the UE, CSI associated with a set of multiple beam groups that each include multiple beams. The communications manager 420 may be configured as or otherwise support a means for transmitting, to the base station in accordance with the beam group reporting configuration, a first uplink message including an indication that the trigger condition has been satisfied. The communications manager 420 may be configured as or otherwise support a means for transmitting, to the base station and based on transmission of the first uplink message, a second uplink message including a measurement report that includes CSI associated with at least a first beam group of the set of multiple beam groups, the first beam group associated with satisfaction of the trigger condition. The communications manager 420 may be configured as or otherwise support a means for receiving, in response to the second uplink message, additional control signaling including beam information for communications between the base station and the UE. The communications manager 420 may be configured as or otherwise support a means for communicating with the base station in accordance with the beam information.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for improved CSI reporting at UEs 115. In particular, aspects of the present disclosure may enable UEs 115 to perform event-triggered group-based CSI reporting. That is, techniques described herein may enable UEs 115-b to transmit CSI reports (and other measurement reports) for groups of multiple beams upon a satisfaction of one or more trigger conditions. As such, techniques described herein may facilitate improved CSI information exchange between UEs 115 and the network, thereby providing improved channel quality information at the network and more efficient, reliable wireless communications.

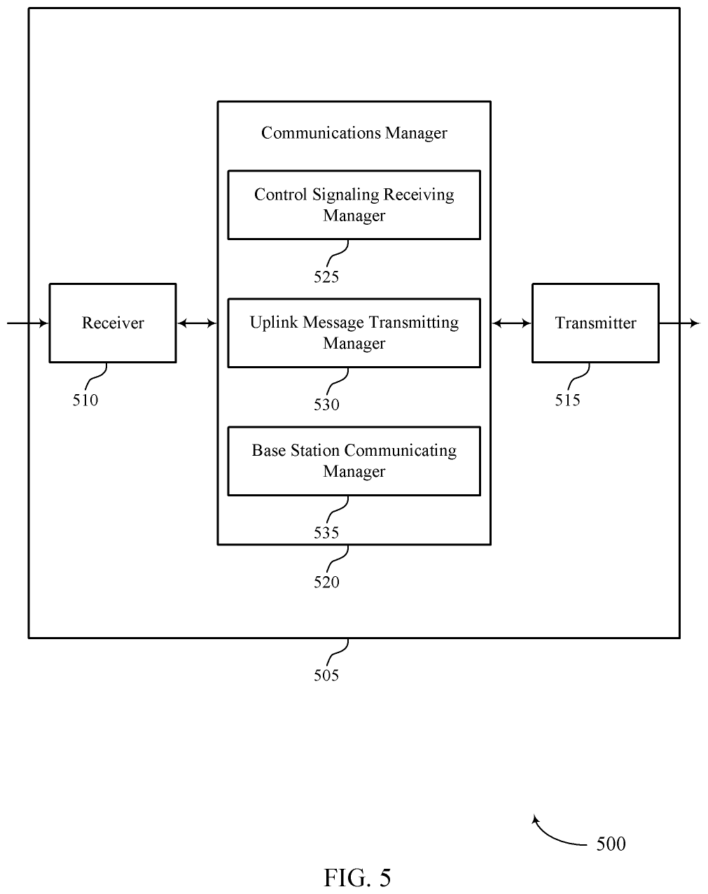

FIG. 5 shows a block diagram 500 of a device 505 that supports techniques for event-triggered beam group reporting in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for event-triggered beam group reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for event-triggered beam group reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for event-triggered beam group reporting as described herein. For example, the communications manager 520 may include a control signaling receiving manager 525, an uplink message transmitting manager 530, a base station communicating manager 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The control signaling receiving manager 525 may be configured as or otherwise support a means for receiving, from a base station, control signaling indicating a beam group reporting configuration that includes a trigger condition for reporting, by the UE, CSI associated with a set of multiple beam groups that each include multiple beams. The uplink message transmitting manager 530 may be configured as or otherwise support a means for transmitting, to the base station in accordance with the beam group reporting configuration, a first uplink message including an indication that the trigger condition has been satisfied. The uplink message transmitting manager 530 may be configured as or otherwise support a means for transmitting, to the base station and based on transmission of the first uplink message, a second uplink message including a measurement report that includes CSI associated with at least a first beam group of the set of multiple beam groups, the first beam group associated with satisfaction of the trigger condition. The control signaling receiving manager 525 may be configured as or otherwise support a means for receiving, in response to the second uplink message, additional control signaling including beam information for communications between the base station and the UE. The base station communicating manager 535 may be configured as or otherwise support a means for communicating with the base station in accordance with the beam information.

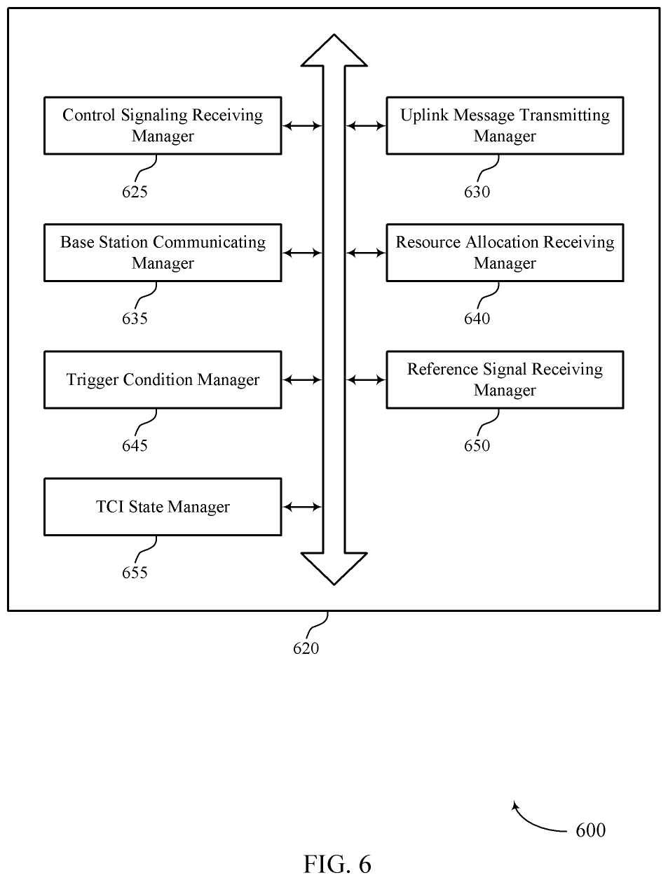

FIG. 6 shows a block diagram 600 of a communications manager 620 that supports techniques for event-triggered beam group reporting in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for event-triggered beam group reporting as described herein. For example, the communications manager 620 may include a control signaling receiving manager 625, an uplink message transmitting manager 630, a base station communicating manager 635, a resource allocation receiving manager 640, a trigger condition manager 645, a reference signal receiving manager 650, a TCI state manager 655, or any combination thereof. Each of these components may communicate, directly or indirectly, with one another (e.g., via one or more buses).

The communications manager 620 may support wireless communication at a UE in accordance with examples as disclosed herein. The control signaling receiving manager 625 may be configured as or otherwise support a means for receiving, from a base station, control signaling indicating a beam group reporting configuration that includes a trigger condition for reporting, by the UE, CSI associated with a set of multiple beam groups that each include multiple beams. The uplink message transmitting manager 630 may be configured as or otherwise support a means for transmitting, to the base station in accordance with the beam group reporting configuration, a first uplink message including an indication that the trigger condition has been satisfied. In some examples, the uplink message transmitting manager 630 may be configured as or otherwise support a means for transmitting, to the base station and based on transmission of the first uplink message, a second uplink message including a measurement report that includes CSI associated with at least a first beam group of the set of multiple beam groups, the first beam group associated with satisfaction of the trigger condition. In some examples, the control signaling receiving manager 625 may be configured as or otherwise support a means for receiving, in response to the second uplink message, additional control signaling including beam information for communications between the base station and the UE. The base station communicating manager 635 may be configured as or otherwise support a means for communicating with the base station in accordance with the beam information.

In some examples, the uplink message transmitting manager 630 may be configured as or otherwise support a means for transmitting, via the first uplink message and based on satisfaction of the trigger condition, a request for a resource for communicating the second uplink message. In some examples, the resource allocation receiving manager 640 may be configured as or otherwise support a means for receiving, from the base station and in response to the request, an indication of the resource, where the second uplink message is transmitted within the resource.

In some examples, the uplink message transmitting manager 630 may be configured as or otherwise support a means for transmitting the request via one or more bit fields within the first uplink message that are associated with reporting CSI associated with the set of multiple beam groups.

In some examples, the beam information includes an indication of one or more beams to be used in communications between the UE and the base station, and the base station communicating manager 635 may be configured as or otherwise support a means for communicating with the base station using the one or more beams.

In some examples, the control signaling receiving manager 625 may be configured as or otherwise support a means for receiving, from the base station via the control signaling, second control signaling, or both, an indication of a set of resources for communicating requests associated with reporting CSI by the UE, where the first uplink message is transmitted within a resource of the set of resources.

In some examples, the uplink message transmitting manager 630 may be configured as or otherwise support a means for transmitting, via the first uplink message, an indication of a CSI report configuration identifier associated with the measurement report, an indication of a first beam group identifier associated with the first beam group, or both, where transmitting the second uplink message, receiving the additional control signaling, or both, is based on the CSI report configuration identifier, the first beam group identifier, or both.

In some examples, the trigger condition manager 645 may be configured as or otherwise support a means for identifying that the trigger condition has been satisfied based on a first beam quality metric associated with the first beam group satisfying a reference beam quality metric, where transmitting the first uplink message is based on identifying that the trigger condition has been satisfied. In some examples, the trigger condition manager 645 may be configured as or otherwise support a means for identifying that the trigger condition has been satisfied based on a set of multiple beam quality metrics associated with the set of multiple beam groups each satisfying a reference beam quality metric, where transmitting the first uplink message is based on identifying that the trigger condition has been satisfied.

In some examples, the TCI state manager 655 may be configured as or otherwise support a means for receiving, from the base station, an activation of a set of multiple TCI states, where the reference beam quality metric includes a beam quality metric associated with one or more activated TCI states of the set of multiple TCI states.

In some examples, the control signaling receiving manager 625 may be configured as or otherwise support a means for receiving, via the control signaling, an indication of the reference beam quality metric, where identifying that the trigger condition has been satisfied is based on receiving the indication of the reference beam quality metric. In some examples, the first beam group includes a set of multiple beams. In some examples, the first beam quality metric includes an average beam quality metric associated with the set of multiple beams, a minimum beam quality metric associated with the set of multiple beams, a maximum beam quality metric associated with the set of multiple beams, or any combination thereof.

In some examples, the control signaling receiving manager 625 may be configured as or otherwise support a means for receiving, via the control signaling, second control signaling, or both, an indication of a set of multiple reference signal sets. In some examples, the reference signal receiving manager 650 may be configured as or otherwise support a means for receiving a set of multiple reference signals associated with the set of multiple reference signal sets using at least a subset of beam groups of the set of multiple beam groups. In some examples, the trigger condition manager 645 may be configured as or otherwise support a means for identifying that the trigger condition has been satisfied based on receiving the set of multiple reference signals, where transmitting the first uplink message is based on identifying that the trigger condition has been satisfied.

In some examples, the set of multiple reference signal sets are associated with one another. In some examples, each reference signal set of the set of multiple reference signal sets includes periodic measurement resources, semi-persistent measurement resources, or both. In some examples, the first uplink message includes a RACH message, an uplink control message, a MAC-CE message, or any combination thereof. In some examples, the measurement report includes an indication of one or more measurements associated with the first beam group, the one or more measurements including an L1-RSRP measurement, an L1-SINR measurement, a PHR measurement, an MPE measurement, an L3-RSRP measurement, an L3-SINR measurement, or any combination thereof.

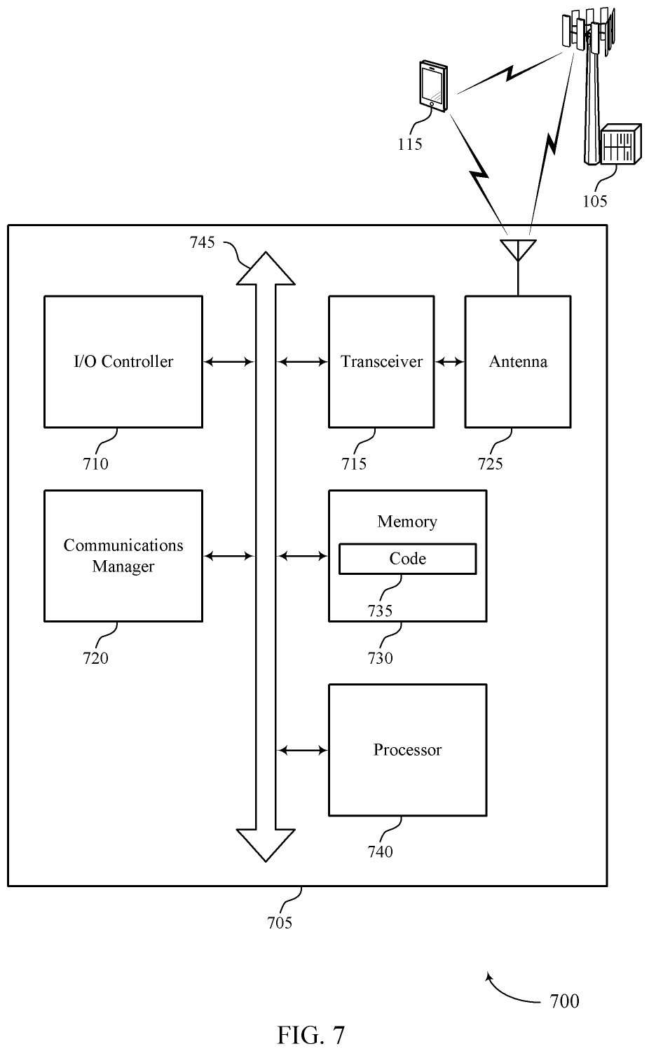

FIG. 7 shows a diagram of a system 700 including a device 705 that supports techniques for event-triggered beam group reporting in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOSR, ANDROIDR, MS-DOSR, MS-WINDOWS®, OS/2R, UNIX®, LINUXR, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for event-triggered beam group reporting). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving, from a base station, control signaling indicating a beam group reporting configuration that includes a trigger condition for reporting, by the UE, CSI associated with a set of multiple beam groups that each include multiple beams. The communications manager 720 may be configured as or otherwise support a means for transmitting, to the base station in accordance with the beam group reporting configuration, a first uplink message including an indication that the trigger condition has been satisfied. The communications manager 720 may be configured as or otherwise support a means for transmitting, to the base station and based on transmission of the first uplink message, a second uplink message including a measurement report that includes CSI associated with at least a first beam group of the set of multiple beam groups, the first beam group associated with satisfaction of the trigger condition. The communications manager 720 may be configured as or otherwise support a means for receiving, in response to the second uplink message, additional control signaling including beam information for communications between the base station and the UE. The communications manager 720 may be configured as or otherwise support a means for communicating with the base station in accordance with the beam information.

By including or configuring the communications manager 720 in accordance with examples as described herein, the device 705 may support techniques for improved CSI reporting at UEs 115. In particular, aspects of the present disclosure may enable UEs 115 to perform event-triggered group-based CSI reporting. That is, techniques described herein may enable UEs 115-b to transmit CSI reports (and other measurement reports) for groups of multiple beams upon a satisfaction of one or more trigger conditions. As such, techniques described herein may facilitate improved CSI information exchange between UEs 115 and the network, thereby providing improved channel quality information at the network and more efficient, reliable wireless communications.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for event-triggered beam group reporting as described herein, or the processor 740 and the memory 730 may be otherwise configured to perform or support such operations.

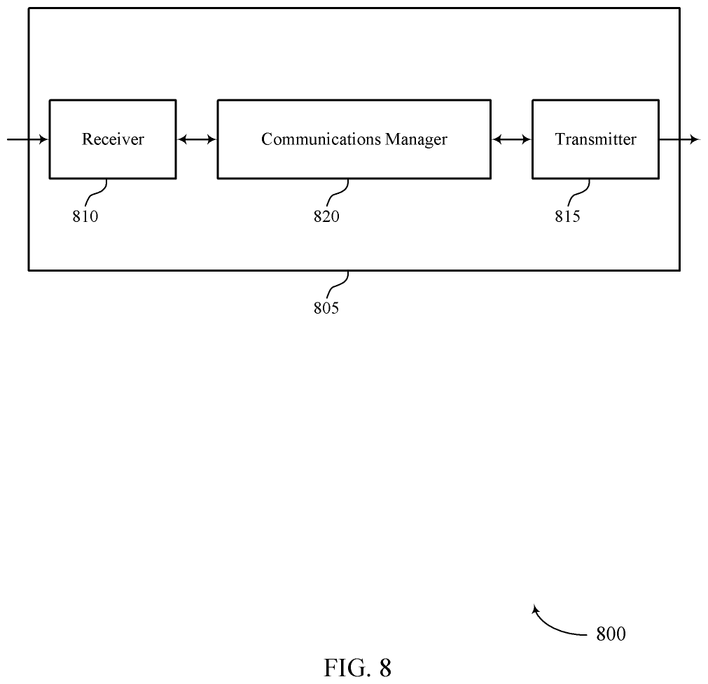

FIG. 8 shows a block diagram 800 of a device 805 that supports techniques for event-triggered beam group reporting in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for event-triggered beam group reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for event-triggered beam group reporting). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for event-triggered beam group reporting as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a base station in accordance with examples as disclosed herein. For example, the communications manager 820 may be configured as or otherwise support a means for transmitting, to a UE, control signaling indicating a beam group reporting configuration that includes a trigger condition for reporting, by the UE, CSI associated with a set of multiple beam groups that each include multiple beams. The communications manager 820 may be configured as or otherwise support a means for receiving, from the UE in accordance with the beam group reporting configuration, a first uplink message including an indication that the trigger condition has been satisfied. The communications manager 820 may be configured as or otherwise support a means for receiving, from the UE and based on the first uplink message, a second uplink message including a measurement report that includes CSI associated with at least a first beam group of the set of multiple beam groups, the first beam group being associated with satisfaction of the trigger condition. The communications manager 820 may be configured as or otherwise support a means for transmitting, in response to the second uplink message, additional control signaling including beam information for communications between the base station and the UE. The communications manager 820 may be configured as or otherwise support a means for communicating with the UE in accordance with the beam information.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for improved CSI reporting at UEs 115. In particular, aspects of the present disclosure may enable UEs 115 to perform event-triggered group-based CSI reporting. That is, techniques described herein may enable UEs 115-b to transmit CSI reports (and other measurement reports) for groups of multiple beams upon a satisfaction of one or more trigger conditions. As such, techniques described herein may facilitate improved CSI information exchange between UEs 115 and the network, thereby providing improved channel quality information at the network and more efficient, reliable wireless communications.

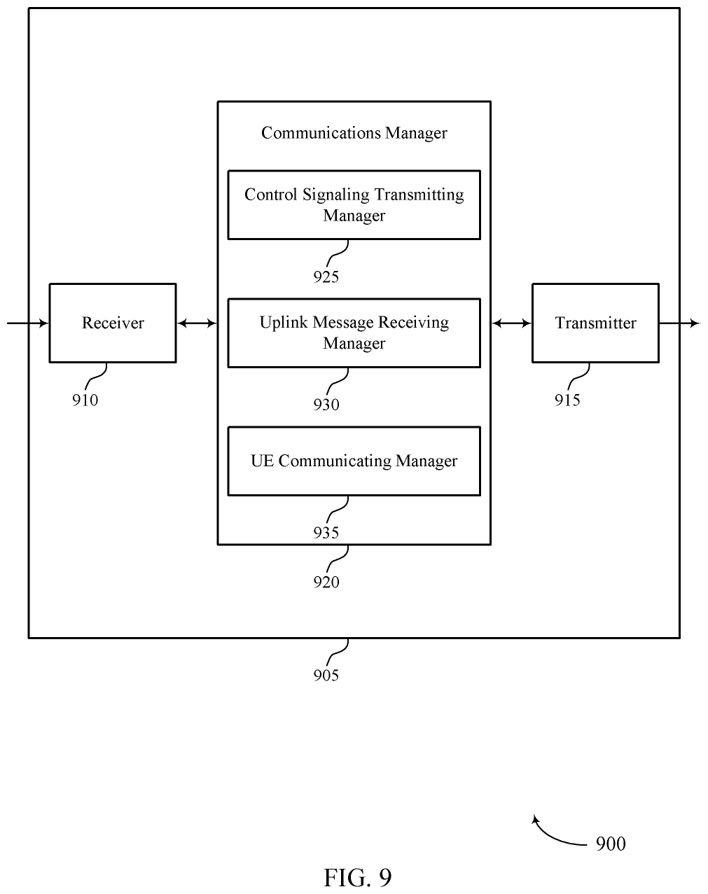

FIG. 9 shows a block diagram 900 of a device 905 that supports techniques for event-triggered beam group reporting in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for event-triggered beam group reporting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for event-triggered beam group reporting). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for event-triggered beam group reporting as described herein. For example, the communications manager 920 may include a control signaling transmitting manager 925, an uplink message receiving manager 930, a UE communicating manager 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. The control signaling transmitting manager 925 may be configured as or otherwise support a means for transmitting, to a UE, control signaling indicating a beam group reporting configuration that includes a trigger condition for reporting, by the UE, CSI associated with a set of multiple beam groups that each include multiple beams. The uplink message receiving manager 930 may be configured as or otherwise support a means for receiving, from the UE in accordance with the beam group reporting configuration, a first uplink message including an indication that the trigger condition has been satisfied. The uplink message receiving manager 930 may be configured as or otherwise support a means for receiving, from the UE and based on the first uplink message, a second uplink message including a measurement report that includes CSI associated with at least a first beam group of the set of multiple beam groups, the first beam group being associated with satisfaction of the trigger condition. The control signaling transmitting manager 925 may be configured as or otherwise support a means for transmitting, in response to the second uplink message, additional control signaling including beam information for communications between the base station and the UE. The UE communicating manager 935 may be configured as or otherwise support a means for communicating with the UE in accordance with the beam information.

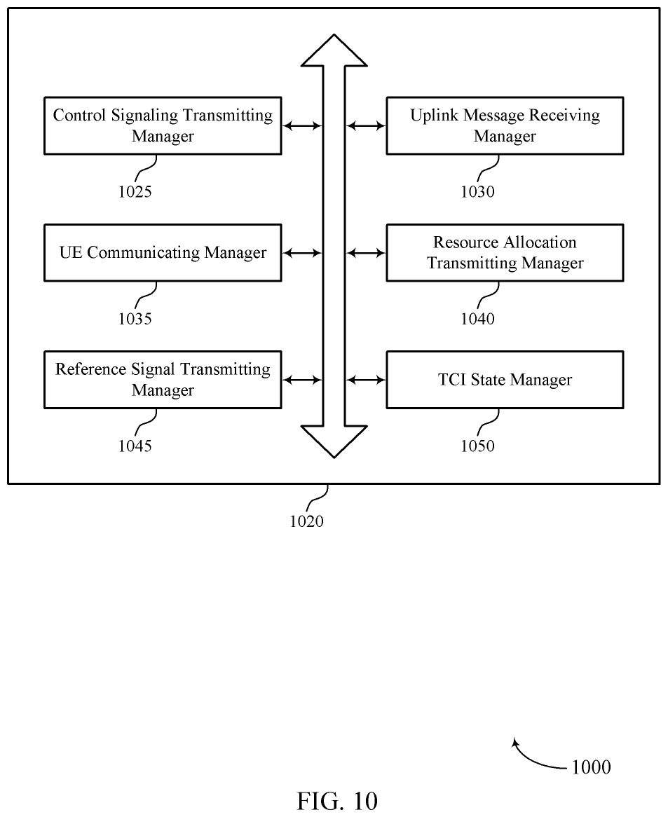

FIG. 10 shows a block diagram 1000 of a communications manager 1020 that supports techniques for event-triggered beam group reporting in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for event-triggered beam group reporting as described herein. For example, the communications manager 1020 may include a control signaling transmitting manager 1025, an uplink message receiving manager 1030, a UE communicating manager 1035, a resource allocation transmitting manager 1040, a reference signal transmitting manager 1045, a TCI state manager 1050, or any combination thereof. Each of these components may communicate, directly or indirectly, with one another (e.g., via one or more buses).

The communications manager 1020 may support wireless communication at a base station in accordance with examples as disclosed herein. The control signaling transmitting manager 1025 may be configured as or otherwise support a means for transmitting, to a UE, control signaling indicating a beam group reporting configuration that includes a trigger condition for reporting, by the UE, CSI associated with a set of multiple beam groups that each include multiple beams. The uplink message receiving manager 1030 may be configured as or otherwise support a means for receiving, from the UE in accordance with the beam group reporting configuration, a first uplink message including an indication that the trigger condition has been satisfied. In some examples, the uplink message receiving manager 1030 may be configured as or otherwise support a means for receiving, from the UE and based on the first uplink message, a second uplink message including a measurement report that includes CSI associated with at least a first beam group of the set of multiple beam groups, the first beam group being associated with satisfaction of the trigger condition. In some examples, the control signaling transmitting manager 1025 may be configured as or otherwise support a means for transmitting, in response to the second uplink message, additional control signaling including beam information for communications between the base station and the UE. The UE communicating manager 1035 may be configured as or otherwise support a means for communicating with the UE in accordance with the beam information.

In some examples, the uplink message receiving manager 1030 may be configured as or otherwise support a means for receiving, via the first uplink message and based on satisfaction of the trigger condition, a request for a resource for communicating the second uplink message. In some examples, the resource allocation transmitting manager 1040 may be configured as or otherwise support a means for transmitting, to the UE and in response to the request, an indication of the resource, where the second uplink message is received within the resource. In some examples, the uplink message receiving manager 1030 may be configured as or otherwise support a means for receiving the request via one or more bit fields within the first uplink message that are associated with reporting CSI associated with the set of multiple beam groups.

In some examples, the control signaling transmitting manager 1025 may be configured as or otherwise support a means for transmitting, to the UE via the control signaling, second control signaling, or both, an indication of a set of resources for communicating requests associated with reporting CSI by the UE, where the first uplink message is received within a resource of the set of resources.

In some examples, the uplink message receiving manager 1030 may be configured as or otherwise support a means for receiving, via the first uplink message, an indication of a CSI report identifier (e.g., CSI report configuration ID) associated with the measurement report, an indication of a first beam group identifier associated with the first beam group, or both, where receiving the second uplink message, transmitting the additional control signaling, or both, is based on the CSI report identifier, the first beam group identifier, or both. In some examples, the trigger condition is satisfied based on a first beam quality metric associated with the first beam group satisfying a reference beam quality metric. In some examples, receiving the first uplink message is based on the trigger condition being satisfied.

In some examples, the trigger condition is satisfied based on a set of multiple beam quality metrics associated with the set of multiple beam groups each satisfying a reference beam quality metric. In some examples, receiving the first uplink message is based on the trigger condition being satisfied.

In some examples, the TCI state manager 1050 may be configured as or otherwise support a means for transmitting, to the UE, an activation of a set of multiple TCI states, where the reference beam quality metric includes a beam quality metric associated with one or more activated TCI states of the set of multiple TCI states.

In some examples, the control signaling transmitting manager 1025 may be configured as or otherwise support a means for transmitting, via the control signaling, an indication of the reference beam quality metric. In some examples, the first beam group includes a set of multiple beams. In some examples, the first beam quality metric includes an average beam quality metric associated with the set of multiple beams, a minimum beam quality metric associated with the set of multiple beams, a maximum beam quality metric associated with the set of multiple beams, or any combination thereof.

In some examples, the control signaling transmitting manager 1025 may be configured as or otherwise support a means for transmitting, via the control signaling, second control signaling, or both, an indication of a set of multiple reference signal sets. In some examples, the reference signal transmitting manager 1045 may be configured as or otherwise support a means for transmitting a set of multiple reference signals associated with the set of multiple reference signal sets using at least a subset of beam groups of the set of multiple beam groups, where the trigger condition is satisfied based on the set of multiple reference signals. In some examples, the set of multiple reference signal sets are associated with one another. In some examples, each reference signal set of the set of multiple reference signal sets includes periodic measurement resources, semi-persistent measurement resources, or both.

In some examples, the first uplink message includes a RACH message, an uplink control message, a MAC-CE message, or any combination thereof. In some examples, the measurement report includes an indication of one or more measurements associated with the first beam group, the one or more measurements including an L1-RSRP measurement, an L1-SINR measurement, a PHR measurement, an MPE measurement, an L3-RSRP measurement, an L3-SINR measurement, or any combination thereof.

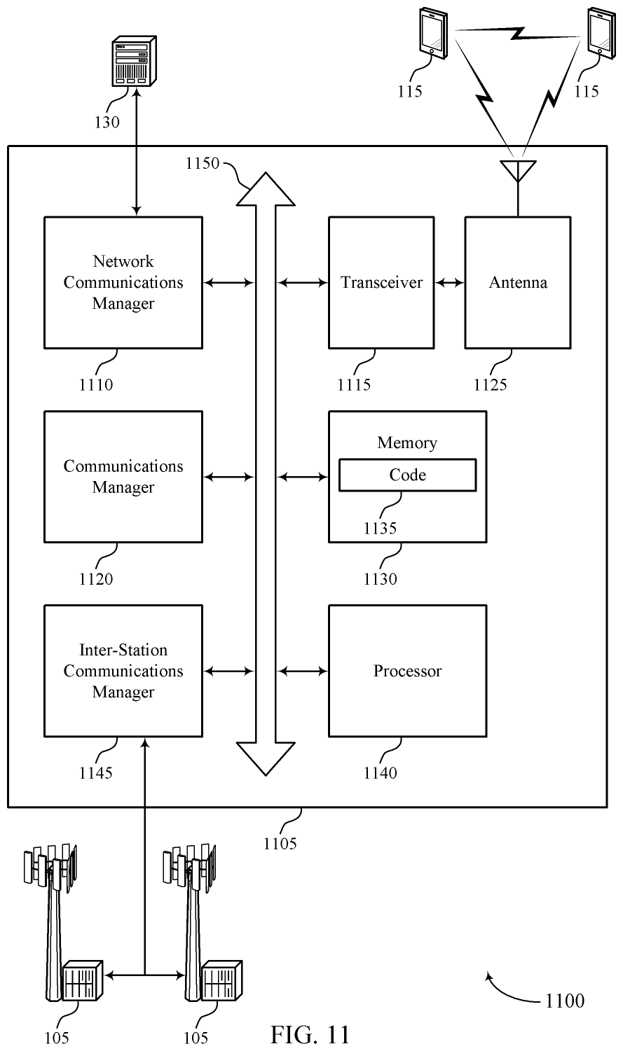

FIG. 11 shows a diagram of a system 1100 including a device 1105 that supports techniques for event-triggered beam group reporting in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for event-triggered beam group reporting). For example, the device 1105 or a component of the device 1105 may include a processor 1140 and memory 1130 coupled with or to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a base station in accordance with examples as disclosed herein. For example, the communications manager 1120 may be configured as or otherwise support a means for transmitting, to a UE, control signaling indicating a beam group reporting configuration that includes a trigger condition for reporting, by the UE, CSI associated with a set of multiple beam groups that each include multiple beams. The communications manager 1120 may be configured as or otherwise support a means for receiving, from the UE in accordance with the beam group reporting configuration, a first uplink message including an indication that the trigger condition has been satisfied. The communications manager 1120 may be configured as or otherwise support a means for receiving, from the UE and based on the first uplink message, a second uplink message including a measurement report that includes CSI associated with at least a first beam group of the set of multiple beam groups, the first beam group being associated with satisfaction of the trigger condition. The communications manager 1120 may be configured as or otherwise support a means for transmitting, in response to the second uplink message, additional control signaling including beam information for communications between the base station and the UE. The communications manager 1120 may be configured as or otherwise support a means for communicating with the UE in accordance with the beam information.

By including or configuring the communications manager 1120 in accordance with examples as described herein, the device 1105 may support techniques for improved CSI reporting at UEs 115. In particular, aspects of the present disclosure may enable UEs 115 to perform event-triggered group-based CSI reporting. That is, techniques described herein may enable UEs 115-b to transmit CSI reports (and other measurement reports) for groups of multiple beams upon a satisfaction of one or more trigger conditions. As such, techniques described herein may facilitate improved CSI information exchange between UEs 115 and the network, thereby providing improved channel quality information at the network and more efficient, reliable wireless communications.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for event-triggered beam group reporting as described herein, or the processor 1140 and the memory 1130 may be otherwise configured to perform or support such operations.

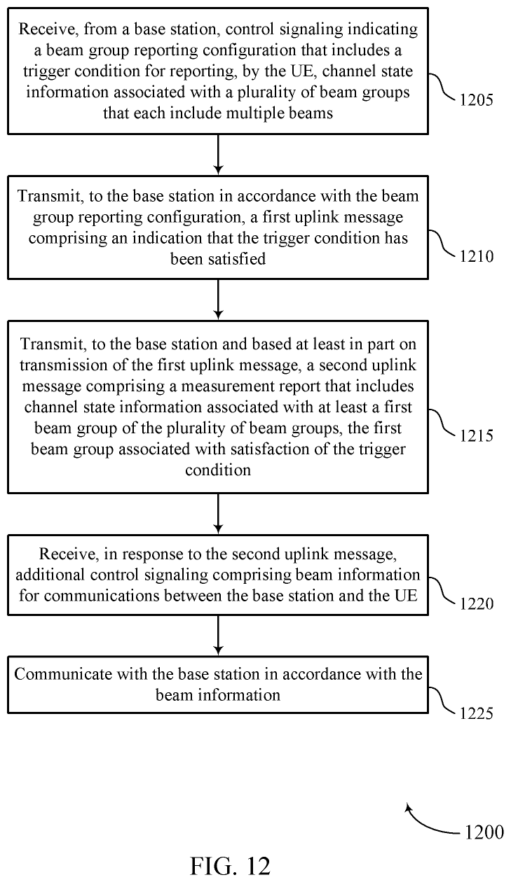

FIG. 12 shows a flowchart illustrating a method 1200 that supports techniques for event-triggered beam group reporting in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving, from a base station, control signaling indicating a beam group reporting configuration that includes a trigger condition for reporting, by the UE, CSI associated with a set of multiple beam groups that each include multiple beams. The operations of 1205 may be performed in accordance with examples as disclosed herein. In some examples, aspects of the operations of 1205 may be performed by a control signaling receiving manager 625 as described with reference to FIG. 6.

At 1210, the method may include transmitting, to the base station in accordance with the beam group reporting configuration, a first uplink message including an indication that the trigger condition has been satisfied. The operations of 1210 may be performed in accordance with examples as disclosed herein. In some examples, aspects of the operations of 1210 may be performed by an uplink message transmitting manager 630 as described with reference to FIG. 6.

At 1215, the method may include transmitting, to the base station and based on transmission of the first uplink message, a second uplink message including a measurement report that includes CSI associated with at least a first beam group of the set of multiple beam groups, the first beam group associated with satisfaction of the trigger condition. The operations of 1215 may be performed in accordance with examples as disclosed herein. In some examples, aspects of the operations of 1215 may be performed by an uplink message transmitting manager 630 as described with reference to FIG. 6.

At 1220, the method may include receiving, in response to the second uplink message, additional control signaling including beam information for communications between the base station and the UE. The operations of 1220 may be performed in accordance with examples as disclosed herein. In some examples, aspects of the operations of 1220 may be performed by a control signaling receiving manager 625 as described with reference to FIG. 6.

At 1225, the method may include communicating with the base station in accordance with the beam information. The operations of 1225 may be performed in accordance with examples as disclosed herein. In some examples, aspects of the operations of 1225 may be performed by a base station communicating manager 635 as described with reference to FIG. 6.

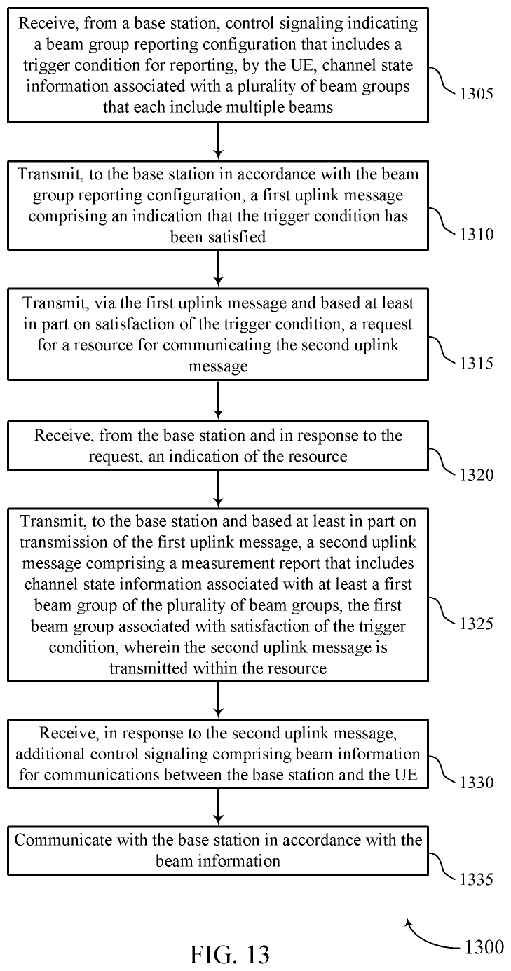

FIG. 13 shows a flowchart illustrating a method 1300 that supports techniques for event-triggered beam group reporting in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, control signaling indicating a beam group reporting configuration that includes a trigger condition for reporting, by the UE, CSI associated with a set of multiple beam groups that each include multiple beams. The operations of 1305 may be performed in accordance with examples as disclosed herein. In some examples, aspects of the operations of 1305 may be performed by a control signaling receiving manager 625 as described with reference to FIG. 6.

At 1310, the method may include transmitting, to the base station in accordance with the beam group reporting configuration, a first uplink message including an indication that the trigger condition has been satisfied. The operations of 1310 may be performed in accordance with examples as disclosed herein. In some examples, aspects of the operations of 1310 may be performed by an uplink message transmitting manager 630 as described with reference to FIG. 6.

At 1315, the method may include transmitting, via the first uplink message and based on satisfaction of the trigger condition, a request for a resource for communicating the second uplink message. The operations of 1315 may be performed in accordance with examples as disclosed herein. In some examples, aspects of the operations of 1315 may be performed by an uplink message transmitting manager 630 as described with reference to FIG. 6.

At 1320, the method may include receiving, from the base station and in response to the request, an indication of the resource. The operations of 1320 may be performed in accordance with examples as disclosed herein. In some examples, aspects of the operations of 1320 may be performed by a resource allocation receiving manager 640 as described with reference to FIG. 6.

At 1325, the method may include transmitting, to the base station and based on transmission of the first uplink message, a second uplink message including a measurement report that includes CSI associated with at least a first beam group of the set of multiple beam groups, the first beam group associated with satisfaction of the trigger condition, where the second uplink message is transmitted within the resource. The operations of 1325 may be performed in accordance with examples as disclosed herein. In some examples, aspects of the operations of 1325 may be performed by an uplink message transmitting manager 630 as described with reference to FIG. 6.

At 1330, the method may include receiving, in response to the second uplink message, additional control signaling including beam information for communications between the base station and the UE. The operations of 1330 may be performed in accordance with examples as disclosed herein. In some examples, aspects of the operations of 1330 may be performed by a control signaling receiving manager 625 as described with reference to FIG. 6.

At 1335, the method may include communicating with the base station in accordance with the beam information. The operations of 1335 may be performed in accordance with examples as disclosed herein. In some examples, aspects of the operations of 1335 may be performed by a base station communicating manager 635 as described with reference to FIG. 6.

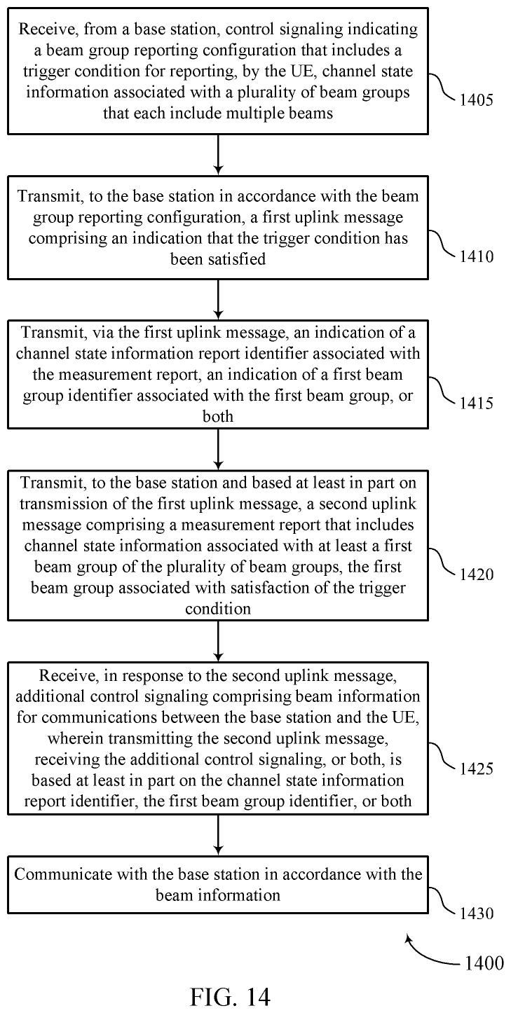

FIG. 14 shows a flowchart illustrating a method 1400 that supports techniques for event-triggered beam group reporting in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, control signaling indicating a beam group reporting configuration that includes a trigger condition for reporting, by the UE, CSI associated with a set of multiple beam groups that each include multiple beams. The operations of 1405 may be performed in accordance with examples as disclosed herein. In some examples, aspects of the operations of 1405 may be performed by a control signaling receiving manager 625 as described with reference to FIG. 6.

At 1410, the method may include transmitting, to the base station in accordance with the beam group reporting configuration, a first uplink message including an indication that the trigger condition has been satisfied. The operations of 1410 may be performed in accordance with examples as disclosed herein. In some examples, aspects of the operations of 1410 may be performed by an uplink message transmitting manager 630 as described with reference to FIG. 6.

At 1415, the method may include transmitting, via the first uplink message, an indication of a CSI report identifier associated with the measurement report, an indication of a first beam group identifier associated with the first beam group, or both. The operations of 1415 may be performed in accordance with examples as disclosed herein. In some examples, aspects of the operations of 1415 may be performed by an uplink message transmitting manager 630 as described with reference to FIG. 6.

At 1420, the method may include transmitting, to the base station and based on transmission of the first uplink message, a second uplink message including a measurement report that includes CSI associated with at least a first beam group of the set of multiple beam groups, the first beam group associated with satisfaction of the trigger condition. The operations of 1420 may be performed in accordance with examples as disclosed herein. In some examples, aspects of the operations of 1420 may be performed by an uplink message transmitting manager 630 as described with reference to FIG. 6.

At 1425, the method may include receiving, in response to the second uplink message, additional control signaling including beam information for communications between the base station and the UE, where transmitting the second uplink message, receiving the additional control signaling, or both, is based on the CSI report identifier, the first beam group identifier, or both. The operations of 1425 may be performed in accordance with examples as disclosed herein. In some examples, aspects of the operations of 1425 may be performed by a control signaling receiving manager 625 as described with reference to FIG. 6.

At 1430, the method may include communicating with the base station in accordance with the beam information. The operations of 1430 may be performed in accordance with examples as disclosed herein. In some examples, aspects of the operations of 1430 may be performed by a base station communicating manager 635 as described with reference to FIG. 6.

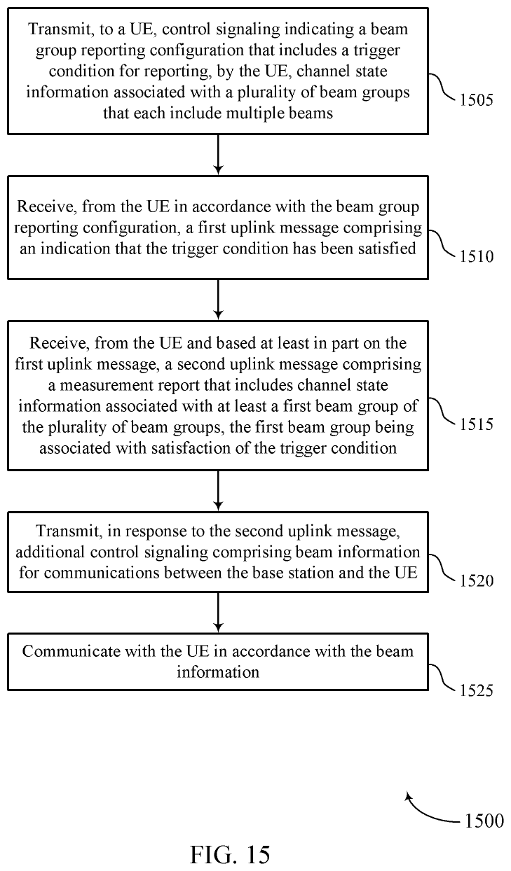

FIG. 15 shows a flowchart illustrating a method 1500 that supports techniques for event-triggered beam group reporting in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, control signaling indicating a beam group reporting configuration that includes a trigger condition for reporting, by the UE, CSI associated with a set of multiple beam groups that each include multiple beams. The operations of 1505 may be performed in accordance with examples as disclosed herein. In some examples, aspects of the operations of 1505 may be performed by a control signaling transmitting manager 1025 as described with reference to FIG. 10.

At 1510, the method may include receiving, from the UE in accordance with the beam group reporting configuration, a first uplink message including an indication that the trigger condition has been satisfied. The operations of 1510 may be performed in accordance with examples as disclosed herein. In some examples, aspects of the operations of 1510 may be performed by an uplink message receiving manager 1030 as described with reference to FIG. 10.

At 1515, the method may include receiving, from the UE and based on the first uplink message, a second uplink message including a measurement report that includes CSI associated with at least a first beam group of the set of multiple beam groups, the first beam group being associated with satisfaction of the trigger condition. The operations of 1515 may be performed in accordance with examples as disclosed herein. In some examples, aspects of the operations of 1515 may be performed by an uplink message receiving manager 1030 as described with reference to FIG. 10.

At 1520, the method may include transmitting, in response to the second uplink message, additional control signaling including beam information for communications between the base station and the UE. The operations of 1520 may be performed in accordance with examples as disclosed herein. In some examples, aspects of the operations of 1520 may be performed by a control signaling transmitting manager 1025 as described with reference to FIG. 10.

At 1525, the method may include communicating with the UE in accordance with the beam information. The operations of 1525 may be performed in accordance with examples as disclosed herein. In some examples, aspects of the operations of 1525 may be performed by a UE communicating manager 1035 as described with reference to FIG. 10.

The following provides an overview of aspects of the present disclosure:

Aspect 1: A method for wireless communication at a UE, comprising: receiving, from a base station, control signaling indicating a beam group reporting configuration that includes a trigger condition for reporting, by the UE, CSI associated with a plurality of beam groups that each include multiple beams: transmitting, to the base station in accordance with the beam group reporting configuration, a first uplink message comprising an indication that the trigger condition has been satisfied; transmitting, to the base station and based at least in part on transmission of the first uplink message, a second uplink message comprising a measurement report that includes CSI associated with at least a first beam group of the plurality of beam groups, the first beam group associated with satisfaction of the trigger condition: receiving, in response to the second uplink message, additional control signaling comprising beam information for communications between the base station and the UE; and communicating with the base station in accordance with the beam information.

Aspect 2: The method of aspect 1, further comprising: transmitting, via the first uplink message and based at least in part on satisfaction of the trigger condition, a request for a resource for communicating the second uplink message; and receiving, from the base station and in response to the request, an indication of the resource, wherein the second uplink message is transmitted within the resource.

Aspect 3: The method of aspect 2, further comprising: transmitting the request via one or more bit fields within the first uplink message that are associated with reporting CSI associated with the plurality of beam groups.

Aspect 4: The method of any of aspects 1 through 3, wherein the beam information comprises an indication of one or more beams to be used in communications between the UE and the base station, the method further comprising: communicating with the base station using the one or more beams.

Aspect 5: The method of any of aspects 1 through 4, further comprising: receiving, from the base station via the control signaling, second control signaling, or both, an indication of a set of resources for communicating requests associated with reporting CSI by the UE, wherein the first uplink message is transmitted within a resource of the set of resources.

Aspect 6: The method of any of aspects 1 through 5, further comprising: transmitting, via the first uplink message, an indication of a CSI report identifier associated with the measurement report, an indication of a first beam group identifier associated with the first beam group, or both, wherein transmitting the second uplink message, receiving the additional control signaling, or both, is based at least in part on the CSI report identifier, the first beam group identifier, or both.

Aspect 7: The method of any of aspects 1 through 6, further comprising: identifying that the trigger condition has been satisfied based at least in part on a first beam quality metric associated with the first beam group satisfying a reference beam quality metric, wherein transmitting the first uplink message is based at least in part on identifying that the trigger condition has been satisfied.

Aspect 8: The method of aspect 7, further comprising: identifying that the trigger condition has been satisfied based at least in part on a plurality of beam quality metrics associated with the plurality of beam groups each satisfying a reference beam quality metric, wherein transmitting the first uplink message is based at least in part on identifying that the trigger condition has been satisfied.

Aspect 9: The method of any of aspects 7 through 8, further comprising: receiving, from the base station, an activation of a plurality of TCI states, wherein the reference beam quality metric comprises a beam quality metric associated with one or more activated TCI states of the plurality of TCI states.

Aspect 10: The method of any of aspects 7 through 9, further comprising: receiving, via the control signaling, an indication of the reference beam quality metric, wherein identifying that the trigger condition has been satisfied is based at least in part on receiving the indication of the reference beam quality metric.

Aspect 11: The method of any of aspects 7 through 10, wherein the first beam group comprises a plurality of beams, the first beam quality metric comprises an average beam quality metric associated with the plurality of beams, a minimum beam quality metric associated with the plurality of beams, a maximum beam quality metric associated with the plurality of beams, or any combination thereof.

Aspect 12: The method of any of aspects 1 through 11, further comprising: receiving, via the control signaling, second control signaling, or both, an indication of a plurality of reference signal sets: receiving a plurality of reference signals associated with the plurality of reference signal sets using at least a subset of beam groups of the plurality of beam groups; and identifying that the trigger condition has been satisfied based at least in part on receiving the plurality of reference signals, wherein transmitting the first uplink message is based at least in part on identifying that the trigger condition has been satisfied.

Aspect 13: The method of aspect 12, wherein the plurality of reference signal sets are associated with one another, and each reference signal set of the plurality of reference signal sets comprises periodic measurement resources, semi-persistent measurement resources, or both.

Aspect 14: The method of any of aspects 1 through 13, wherein the first uplink message comprises a RACH message, an uplink control message, a MAC-CE message, or any combination thereof.

Aspect 15: The method of any of aspects 1 through 14, wherein the measurement report comprises an indication of one or more measurements associated with the first beam group, the one or more measurements comprising an L1-RSRP measurement, an L1-SINR measurement, a PHR measurement, an MPE measurement, an L3-RSRP measurement, an L3-SINR measurement, or any combination thereof.

Aspect 16: A method for wireless communication at a base station, comprising: transmitting, to a UE, control signaling indicating a beam group reporting configuration that includes a trigger condition for reporting, by the UE, CSI associated with a plurality of beam groups that each include multiple beams: receiving, from the UE in accordance with the beam group reporting configuration, a first uplink message comprising an indication that the trigger condition has been satisfied: receiving, from the UE and based at least in part on the first uplink message, a second uplink message comprising a measurement report that includes CSI associated with at least a first beam group of the plurality of beam groups, the first beam group being associated with satisfaction of the trigger condition: transmitting, in response to the second uplink message, additional control signaling comprising beam information for communications between the base station and the UE; and communicating with the UE in accordance with the beam information.

Aspect 17: The method of aspect 16, further comprising: receiving, via the first uplink message and based at least in part on satisfaction of the trigger condition, a request for a resource for communicating the second uplink message; and transmitting, to the UE and in response to the request, an indication of the resource, wherein the second uplink message is received within the resource.

Aspect 18: The method of aspect 17, further comprising: receiving the request via one or more bit fields within the first uplink message that are associated with reporting CSI associated with the plurality of beam groups.

Aspect 19: The method of any of aspects 16 through 18, further comprising: transmitting, to the UE via the control signaling, second control signaling, or both, an indication of a set of resources for communicating requests associated with reporting CSI by the UE, wherein the first uplink message is received within a resource of the set of resources.

Aspect 20: The method of any of aspects 16 through 19, further comprising: receiving, via the first uplink message, an indication of a CSI report identifier associated with the measurement report, an indication of a first beam group identifier associated with the first beam group, or both, wherein receiving the second uplink message, transmitting the additional control signaling, or both, is based at least in part on the CSI report identifier, the first beam group identifier, or both.

Aspect 21: The method of any of aspects 16 through 20, wherein the trigger condition is satisfied based at least in part on a first beam quality metric associated with the first beam group satisfying a reference beam quality metric, receiving the first uplink message is based at least in part on the trigger condition being satisfied.

Aspect 22: The method of aspect 21, wherein the trigger condition is satisfied based at least in part on a plurality of beam quality metrics associated with the plurality of beam groups each satisfying a reference beam quality metric, receiving the first uplink message is based at least in part on the trigger condition being satisfied.

Aspect 23: The method of any of aspects 21 through 22, further comprising: transmitting, to the UE, an activation of a plurality of TCI states, wherein the reference beam quality metric comprises a beam quality metric associated with one or more activated TCI states of the plurality of TCI states.

Aspect 24: The method of any of aspects 21 through 23, further comprising: transmitting, via the control signaling, an indication of the reference beam quality metric.

Aspect 25: The method of any of aspects 21 through 24, wherein the first beam group comprises a plurality of beams, the first beam quality metric comprises an average beam quality metric associated with the plurality of beams, a minimum beam quality metric associated with the plurality of beams, a maximum beam quality metric associated with the plurality of beams, or any combination thereof.

Aspect 26: The method of any of aspects 16 through 25, further comprising: transmitting, via the control signaling, second control signaling, or both, an indication of a plurality of reference signal sets; and transmitting a plurality of reference signals associated with the plurality of reference signal sets using at least a subset of beam groups of the plurality of beam groups, wherein the trigger condition is satisfied based at least in part on the plurality of reference signals.

Aspect 27: The method of aspect 26, wherein the plurality of reference signal sets are associated with one another, and each reference signal set of the plurality of reference signal sets comprises periodic measurement resources, semi-persistent measurement resources, or both.

Aspect 28: The method of any of aspects 16 through 27, wherein the first uplink message comprises a RACH message, an uplink control message, a MAC-CE message, or any combination thereof.

Aspect 29: The method of any of aspects 16 through 28, wherein the measurement report comprises an indication of one or more measurements associated with the first beam group, the one or more measurements comprising an L1-RSRP measurement, an L1-SINR measurement, a PHR measurement, an MPE measurement, an L3-RSRP measurement, an L3-SINR measurement, or any combination thereof.

Aspect 30: An apparatus for wireless communication at a UE, comprising a processor: memory coupled with the processor; and instructions stored in the memory and executable by the processor to cause the apparatus to perform a method of any of aspects 1 through 15.

Aspect 31: An apparatus for wireless communication at a UE, comprising at least one means for performing a method of any of aspects 1 through 15.

Aspect 32: A non-transitory computer-readable medium storing code for wireless communication at a UE, the code comprising instructions executable by a processor to perform a method of any of aspects 1 through 15.

Aspect 33: An apparatus for wireless communication at a base station, comprising a processor: memory coupled with the processor; and instructions stored in the memory and executable by the processor to cause the apparatus to perform a method of any of aspects 16 through 29.

Aspect 34: An apparatus for wireless communication at a base station, comprising at least one means for performing a method of any of aspects 16 through 29.

Aspect 35: A non-transitory computer-readable medium storing code for wireless communication at a base station, the code comprising instructions executable by a processor to perform a method of any of aspects 16 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, control signaling indicating a beam group reporting configuration that includes a trigger condition for reporting, by the UE, channel state information associated with a plurality of beam groups that each include multiple beams;
transmitting, to the base station in accordance with the beam group reporting configuration, a first uplink message comprising an indication that the trigger condition has been satisfied;
transmitting, to the base station and based at least in part on transmission of the first uplink message, a second uplink message comprising a measurement report that includes channel state information associated with at least a first beam group of the plurality of beam groups, the first beam group associated with satisfaction of the trigger condition;
receiving, in response to the second uplink message, additional control signaling comprising beam information for communications between the base station and the UE; and
communicating with the base station in accordance with the beam information.

2. The method of claim 1, further comprising:
transmitting, via the first uplink message and based at least in part on satisfaction of the trigger condition, a request for a resource for communicating the second uplink message; and
receiving, from the base station and in response to the request, an indication of the resource, wherein the second uplink message is transmitted within the resource.

3. The method of claim 2, further comprising:
transmitting the request via one or more bit fields within the first uplink message that are associated with reporting channel state information associated with the plurality of beam groups.

4. The method of claim 1, wherein the beam information comprises an indication of one or more beams to be used in communications between the UE and the base station, the method further comprising:
communicating with the base station using the one or more beams.

5. The method of claim 1, further comprising:
receiving, from the base station via the control signaling, second control signaling, or both, an indication of a set of resources for communicating requests associated with reporting channel state information by the UE, wherein the first uplink message is transmitted within a resource of the set of resources.

6. The method of claim 1, further comprising:
transmitting, via the first uplink message, an indication of a channel state information report identifier associated with the measurement report, an indication of a first beam group identifier associated with the first beam group, or both, wherein transmitting the second uplink message, receiving the additional control signaling, or both, is based at least in part on the channel state information report identifier, the first beam group identifier, or both.

7. The method of claim 1, further comprising:
identifying that the trigger condition has been satisfied based at least in part on a first beam quality metric associated with the first beam group satisfying a reference beam quality metric, wherein transmitting the first uplink message is based at least in part on identifying that the trigger condition has been satisfied.

8. The method of claim 7, further comprising:
identifying that the trigger condition has been satisfied based at least in part on a plurality of beam quality metrics associated with the plurality of beam groups each satisfying a reference beam quality metric, wherein transmitting the first uplink message is based at least in part on identifying that the trigger condition has been satisfied.

9. The method of claim 7, further comprising:
receiving, from the base station, an activation of a plurality of transmission configuration indicator states, wherein the reference beam quality metric comprises a beam quality metric associated with one or more activated transmission configuration indicator states of the plurality of transmission configuration indicator states.

10. The method of claim 7, further comprising:
receiving, via the control signaling, an indication of the reference beam quality metric, wherein identifying that the trigger condition has been satisfied is based at least in part on receiving the indication of the reference beam quality metric.

11. The method of claim 7, wherein the first beam group comprises a plurality of beams, and wherein the first beam quality metric comprises an average beam quality metric associated with the plurality of beams, a minimum beam quality metric associated with the plurality of beams, a maximum beam quality metric associated with the plurality of beams, or any combination thereof.

12. The method of claim 1, further comprising:
receiving, via the control signaling, second control signaling, or both, an indication of a plurality of reference signal sets;
receiving a plurality of reference signals associated with the plurality of reference signal sets using at least a subset of beam groups of the plurality of beam groups; and
identifying that the trigger condition has been satisfied based at least in part on receiving the plurality of reference signals, wherein transmitting the first uplink message is based at least in part on identifying that the trigger condition has been satisfied.

13. The method of claim 12, wherein the plurality of reference signal sets are associated with one another, wherein each reference signal set of the plurality of reference signal sets comprises periodic measurement resources, semi-persistent measurement resources, or both.

14. The method of claim 1, wherein the first uplink message comprises a random access channel message, an uplink control message, a medium access control-control element message, or any combination thereof.

15. The method of claim 1, wherein the measurement report comprises an indication of one or more measurements associated with the first beam group, the one or more measurements comprising a layer one-reference signal received power measurement, a layer one-signal-to-interference-plus-noise ratio measurement, a power headroom measurement, a maximum permissible exposure measurement, a layer three-reference signal received power measurement, a layer three-signal-to-interference-plus-noise ratio measurement, or any combination thereof.

16. A method for wireless communication at a base station, comprising:
transmitting, to a user equipment (UE), control signaling indicating a beam group reporting configuration that includes a trigger condition for reporting, by the UE, channel state information associated with a plurality of beam groups that each include multiple beams;
receiving, from the UE in accordance with the beam group reporting configuration, a first uplink message comprising an indication that the trigger condition has been satisfied;
receiving, from the UE and based at least in part on the first uplink message, a second uplink message comprising a measurement report that includes channel state information associated with at least a first beam group of the plurality of beam groups, the first beam group being associated with satisfaction of the trigger condition;
transmitting, in response to the second uplink message, additional control signaling comprising beam information for communications between the base station and the UE; and
communicating with the UE in accordance with the beam information.

17. The method of claim 16, further comprising:
receiving, via the first uplink message and based at least in part on satisfaction of the trigger condition, a request for a resource for communicating the second uplink message; and
transmitting, to the UE and in response to the request, an indication of the resource, wherein the second uplink message is received within the resource.

18. The method of claim 17, further comprising:
receiving the request via one or more bit fields within the first uplink message that are associated with reporting channel state information associated with the plurality of beam groups.

19. The method of claim 16, further comprising:
transmitting, to the UE via the control signaling, second control signaling, or both, an indication of a set of resources for communicating requests associated with reporting channel state information by the UE, wherein the first uplink message is received within a resource of the set of resources.

20. The method of claim 16, further comprising:
receiving, via the first uplink message, an indication of a channel state information report identifier associated with the measurement report, an indication of a first beam group identifier associated with the first beam group, or both, wherein receiving the second uplink message, transmitting the additional control signaling, or both, is based at least in part on the channel state information report identifier, the first beam group identifier, or both.

21. The method of claim 16, wherein the trigger condition is satisfied based at least in part on a first beam quality metric associated with the first beam group satisfying a reference beam quality metric, wherein receiving the first uplink message is based at least in part on the trigger condition being satisfied.

22. The method of claim 21, wherein the trigger condition is satisfied based at least in part on a plurality of beam quality metrics associated with the plurality of beam groups each satisfying a reference beam quality metric, wherein receiving the first uplink message is based at least in part on the trigger condition being satisfied.

23. The method of claim 21, further comprising:
transmitting, to the UE, an activation of a plurality of transmission configuration indicator states, wherein the reference beam quality metric comprises a beam quality metric associated with one or more activated transmission configuration indicator states of the plurality of transmission configuration indicator states.

24. The method of claim 21, further comprising:
transmitting, via the control signaling, an indication of the reference beam quality metric.

25. The method of claim 21, wherein the first beam group comprises a plurality of beams, and wherein the first beam quality metric comprises an average beam quality metric associated with the plurality of beams, a minimum beam quality metric associated with the plurality of beams, a maximum beam quality metric associated with the plurality of beams, or any combination thereof.

26. The method of claim 16, further comprising:
transmitting, via the control signaling, second control signaling, or both, an indication of a plurality of reference signal sets; and
transmitting a plurality of reference signals associated with the plurality of reference signal sets using at least a subset of beam groups of the plurality of beam groups, wherein the trigger condition is satisfied based at least in part on the plurality of reference signals.

27. The method of claim 26, wherein the plurality of reference signal sets are associated with one another, wherein each reference signal set of the plurality of reference signal sets comprises periodic measurement resources, semi-persistent measurement resources, or both.

28. The method of claim 16, wherein the first uplink message comprises a random access channel message, an uplink control message, a medium access control-control element message, or any combination thereof.

29. An apparatus for wireless communication, comprising:
a processor;
memory coupled with the processor; and
instructions stored in the memory and executable by the processor to cause the apparatus to:
receive, from a base station, control signaling indicating a beam group reporting configuration that includes a trigger condition for reporting, by a user equipment (UE), channel state information associated with a plurality of beam groups that each include multiple beams;
transmit, to the base station in accordance with the beam group reporting configuration, a first uplink message comprising an indication that the trigger condition has been satisfied;
transmit, to the base station and based at least in part on transmission of the first uplink message, a second uplink message comprising a measurement report that includes channel state information associated with at least a first beam group of the plurality of beam groups, the first beam group associated with satisfaction of the trigger condition;
receive, in response to the second uplink message, additional control signaling comprising beam information for communications between the base station and the UE; and
communicate with the base station in accordance with the beam information.

30. An apparatus for wireless communication, comprising:
a processor;
memory coupled with the processor; and
instructions stored in the memory and executable by the processor to cause the apparatus to:
transmit, to a user equipment (UE), control signaling indicating a beam group reporting configuration that includes a trigger condition for reporting, by the UE, channel state information associated with a plurality of beam groups that each include multiple beams;
receive, from the UE in accordance with the beam group reporting configuration, a first uplink message comprising an indication that the trigger condition has been satisfied;
receive, from the UE and based at least in part on the first uplink message, a second uplink message comprising a measurement report that includes channel state information associated with at least a first beam group of the plurality of beam groups, the first beam group being associated with satisfaction of the trigger condition;
transmit, in response to the second uplink message, additional control signaling comprising beam information for communications between a base station and the UE; and
communicate with the UE in accordance with the beam information.
